(19) United States
(12) Patent Application Publication
(10) Pub. No.: US 2005/0288405 A1
(43) Pub. Date: Dec. 29, 2005

(54) Copolymers containing diimide moieties and blends thereof

(75) Inventors: Gerrit De Wit, Ossendrecht (NL); Ganesh Kannan, Evansville, IN (US); Abbas Alli Shaikh, Bangalore (IN)

Correspondence Address: GEAM - O8CV - CPP;IP LEGAL, ONE PLASTICS AVENUE, PITTSFIELD, MA, 01201-3697, US

(73) Assignee: General Electric Company

(21) Appl. No.: 10/879,914

(22) Filed: Jun. 29, 2004

(51) Int. Cl. C08K 5/34; C08K 3/34

(52) U.S. Cl. 524/100; 524/445

(57) ABSTRACT

Novel copolymer composition comprising structural units derived from a substituted or unsubstituted diacid or diester, a substituted or unsubstituted diol and diimide compound have been disclosed. Also disclosed is a thermoplastic resin composition comprising structural units derived from a polymer resin and the copolyester of the present invention. In addition methods for the preparation of the copolymers and thermoplastic composition is discussed and articles derived from said thermoplastic composition is disclosed.

### BACKGROUND OF THE INVENTION

This invention relates to copolymers, more particularly to copolymers of the polyesters with diimide compounds, and blends of these copolymers with thermoplastic resins, which have enhanced heat stability.

Many applications of engineering plastics require polymers that have high heat stability along with other properties such as tensile strength and chemical resistance. Conventional commercial polyesters generally are deficient in T_{g} and thus heat stability, but possess other desired property attributes such as excellent mechanical properties, good surface finishes of molded articles and satisfactory chemical resistance.

Several attempts have been made to prepare copolymers having a high heat of performance. Poly (etherimide-carbonate) block copolymers have been synthesized having a good intrinsic viscosity and good stability. Many polyesteramides are well known in the art. U.S. Pat. Nos. 2,547,113 and 5,672,676 disloses a sequential addition process for the preparation of polyesteramides based on high melting aromatic diamines, diacids and diols. The preparation of diacid containing diimide moiety from 2,2-bis[4-(3,4-dicarboxyphenoxy]propane and crystalline copolyesteretherimides have been disclosed by Haitko et al, in U.S. Pat. No. 4,988,821.

The primary object of the invention is to provide a novel diimide copolymer material and its blend with a thermoplastic resin having excellent heat resistance, cold resistance, processability, strength and moldability properties.

There is a continuing need for thermoplastic compositions having a good balance of transparency, processability, in addition to good mechanical and thermal properties.

### BRIEF DESCRIPTION OF THE INVENTION

The present inventors have unexpectedly discovered a copolymer composition comprising: structural units derived from a substituted or unsubstituted diacid or diester, a substituted or unsubstituted diol and a diimide compound of the formula:
Y—R′—X—R′—Y;
wherein R′ is independently selected from the group consisting of a substituted or unsubstituted alkenyl, allyl, alkyl, aryl, aralkyl, alkaryl, and cycloalkyl; Y is selected from the group consisting of hydroxy, alkoxy, aryloxy, OM, COORS NR₂R₃ group wherein M is a metal cation or ammonium cation and wherein R₁, R₂, R₃ are independently selected from the group consisting of a substituted and unsubstituted alkenyl, allyl, alkyl, aryl, aralkyl, alkaryl, cycloalkyl groups, or hydrogen and X is of the formula: 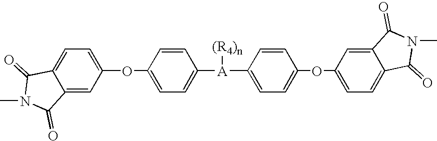
wherein A comprises a sulfur-containing linkage, sulfide, sulfoxide, sulfone; a phosphorus-containing linkage, phosphinyl, phosphonyl; an ether linkage; a carbonyl group; a tertiary nitrogen group; a silicon-containing linkage; silane; siloxy; a cycloaliphatic group; cyclopentylidene, cyclohexylidene, 3,3,5-trimethylcyclohexylidene, methylcyclohexylidene, 2-[2.2.1]-bicycloheptylidene, neopentylidene, cyclopentadecylidene, cyclododecylidene, adamantylidene; an alkylene or alkylidene group, which group may optionally be part of one or more fused rings attached to one or more aromatic groups bearing one hydroxy substituent; an unsaturated alkylidene group; or two or more alkylene or alkylidene groups connected by a moiety different from alkylene or alkylidene and selected from the group consisting of an aromatic linkage, a tertiary nitrogen linkage; an etherlinkage; a carbonyl linkage; a silicon-containing linkage, silane, siloxy; a sulfur-containing linkage, sulfide, sulfoxide, sulfone; a phosphorus-containing linkage, phosphinyl, and phosphonyl; R₄ is selected from the group consisting of a substituted and unsubstituted alkenyl, allyl, alkyl, aryl, aralkyl, alkaryl, or cycloalkyl groups; the letter “n” represents any integer from and including zero through the number of replaceable hydrogens on R₄ available for substitution.

In one embodiment of the present invention is disclosed the method of synthesizing the copolymer. Also disclosed is a thermoplastic resin composition comprising structural units derived from substituted or unsubstituted polymer resin and the copolymer of the present invention, method for the preparation of these thermoplastic resin compositions of the present invention and articles derived from said composition.

Various other features, aspects, and advantages of the present invention will become more apparent with reference to the following description, examples, and appended claims.

### DETAILED DESCRIPTION OF THE INVENTION

The present invention may be understood more readily by reference to the following detailed description of preferred embodiments of the invention and the examples included herein. In this specification and in the claims, which follow, reference will be made to a number of terms which shall be defined to have the following meanings.

The singular forms “a”, “an” and “the” include plural referents unless the context clearly dictates otherwise.

“Optional” or “optionally” means that the subsequently described event or circumstance may or may not occur, and that the description includes instances where the event occurs and instances where it does not.

As used herein the term “polycarbonate” refers to polycarbonates incorporating structural units derived from one or more dihydroxy aromatic compounds and includes copolycarbonates and polyester.

As used herein the term “PCCD” is defined as poly(cyclohexane-1,4-dimethylene cyclohexane-1,4-dicarboxylate).

As used herein the term “aromatic radical” refers to a radical having a valence of at least one and comprising at least one aromatic ring. Examples of aromatic radicals include phenyl, pyridyl, furanyl, thienyl, naphthyl, phenylene, and biphenyl. The term includes groups containing both aromatic and aliphatic components, for example a benzyl group, a phenethyl group or a naphthylmethyl group. The term also includes groups comprising both aromatic and cycloaliphatic groups for example 4-cyclopropylphenyl and 1,2,3,4-tetrahydronaphthalen-1-yl.

As used herein the term “aliphatic radical” refers to a radical having a valence of at least one and consisting of a linear or branched array of atoms which is not cyclic. The array may include heteroatoms such as nitrogen, sulfur and oxygen or may be composed exclusively of carbon and hydrogen. Examples of aliphatic radicals include methyl, methylene, ethyl, ethylene, hexyl, hexamethylene and the like.

As used herein the term “cycloaliphatic radical” refers to a radical having a valance of at least one and comprising an array of atoms which is cyclic but which is not aromatic, and which does not further comprise an aromatic ring. The array may include heteroatoms such as nitrogen, sulfur and oxygen or may be composed exclusively of carbon and hydrogen. Examples of cycloaliphatic radicals include cyclopropyl, cyclopentyl cyclohexyl, 2-cyclohexylethy-1-yl, tetrahydrofuranyl and the like.

The present inventors have unexpectedly discovered a copolymer composition comprising structural units derived from a substituted or unsubstituted diacid or diester, a substituted or unsubstituted diol and a diimide compound. The diimide compound is of the formula (I):
Y—R′—X—R′—Y (1)

where R′ is independently selected from the group consisting of a substituted or unsubstituted alkenyl, allyl, alkyl, aryl, aralkyl, alkaryl, or cycloalkyl; Y is selected from the group consisting of hydroxy, alkoxy, aryloxy, OM, COORS NR₂R₃ group wherein M is a metal cation or ammonium cation and where R₁, R₂, R₃ are independently selected from the group consisting of a substituted and unsubstituted alkenyl, allyl, alkyl, aryl, aralkyl, alkaryl, or cycloalkyl groups and X is of the formula (II): 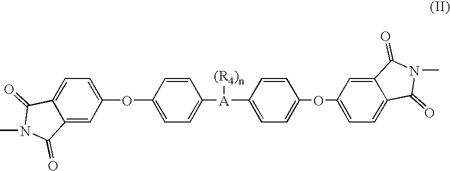
wherein A comprises a sulfur-containing linkage, sulfide, sulfoxide, sulfone; a phosphorus-containing linkage, phosphinyl, phosphonyl; an ether linkage; a carbonyl group; a tertiary nitrogen group; a silicon-containing linkage; silane; siloxy; a cycloaliphatic group; cyclopentylidene, cyclohexylidene, 3,3,5-trimethylcyclohexylidene, methylcyclohexylidene, 2-[2.2.1]-bicycloheptylidene, neopentylidene, cyclopentadecylidene, cyclododecylidene, adamantylidene; an alkylene or alkylidene group, which group may optionally be part of one or more fused rings attached to one or more aromatic groups bearing one hydroxy substituent; an unsaturated alkylidene group; or two or more alkylene or alkylidene groups connected by a moiety different from alkylene or alkylidene and selected from the group consisting of an aromatic linkage, a tertiary nitrogen linkage; an ether linkage; a carbonyl linkage; a silicon-containing linkage, silane, siloxy; a sulfur-containing linkage, sulfide, sulfoxide, sulfone; a phosphorus-containing linkage, phosphinyl, and phosphonyl; R₄ is selected from the group consisting of a substituted and unsubstituted alkenyl, allyl, alkyl, aryl, aralkyl, alkaryl, or cycloalkyl groups; the letter “n” represents any integer from and including zero through the number of replaceable hydrogens on R₄ available for substitution.

In one embodiment of the present invention X comprises substituted aromatic hydrocarbons which include but are not limited to formula (III): 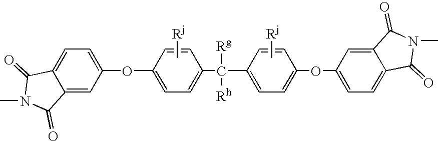
where independently each R^{j} is as defined hereinbefore, and independently R^{g} and R^{h} are hydrogen or a C₁-C₃₀ hydrocarbon group. In one embodiment of the present invention A is an alkylene or alkylidene group, said group may be part of one or more fused rings attached to one or more aromatic groups bearing one hydroxy substituent. Suitable dihydroxy-substituted aromatic hydrocarbons of this type include those containing indane structural units.

The R′ is selected from the group consisting of a substituted or unsubstituted alkenyl, allyl, alkyl, substituted aryl, aralkyl, alkaryl, or cycloalkyl. In one embodiment the R′ is selected from a group consisting of alkyl, cycloalkyl, aralkyl containing at least about C₄-C₃₆ carbon atoms. In an alternate embodiment the R′ is independently selected from C₄-C₂₆ aliphatic, alkylaryl and arylalkyl groups. In another embodiment, R′ is independently selected from substituted and unsubstituted hexyl, heptyl, n-octyl, iso-octyl, tricyclodecyl, n-decyl, iso-decyl, 2-benzylheptyl, dodecyl, tetradecyl, hexadecyl, octadecyl cyclo hexyl, cyclo heptyl, cyclo octyl, cyclo-dodecyl, cyclo-tetradecyl, cyclo-hexadecyl groups, phenyl, naphthyl, partially or completely hydrogenated naphthyl groups. Y is selected from the group consisting of hydroxy, alkoxy, aryloxy, OM, COORᵢ, NR₂R₃ group wherein M is a metal cation or ammonium cation and where R₁, R₂, R₃ are independently an organic radical and are independently selected from the group consisting of a substituted and unsubstituted alkenyl, allyl, alkyl, aryl, aralkyl, alkaryl, or cycloalkyl groups In one embodiment of the present invention Z varies according to whether the compound is a free carboxylic acid or an ester, salt or amide thereof. In the esters and amides, each of R₂ and R₃ is independently an organic radical, most often a C1-C10 alkyl, or C6-C20 aromatic hydrocarbon radical. In one embodiment R₃ is a C6-C18aromatic hydrocarbon radical. M may be one equivalent of a metal or ammonium cation. The preferred metals are usually the alkali and alkaline earth metals. Ammonium cations include those, which are unsubstituted and substituted, the latter including various amine cations.

The present invention related to a copolymer composition, more particularly to a copolyester composition comprising structural units derived from a substituted or unsubstituted diacid, diester, a substituted or unsubstituted diol and a diimide compound. Besides the diimide units the copolyester contains units that are present in normal polyesters as described below:

Typically such polyester resins include crystalline polyester resins such as polyester resins derived from an aliphatic or cycloaliphatic diol, or mixtures thereof, containing from 2 to about 10 carbon atoms and at least one aromatic dicarboxylic acid. Preferred polyesters are derived from an aliphatic diol and an aromatic dicarboxylic acid and have repeating units according to structural formula (IV) 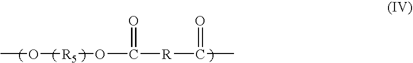
wherein, R₅ is an alkyl radical compromising a dehydroxylated residue derived from an aliphatic or cycloaliphatic diol, or mixtures thereof, containing from 2 to about 20 carbon atoms. R is an aryl radical comprising a decarboxylated residue derived from an aromatic dicarboxylic acid. In one embodiment of the present invention the polyester could be an aliphatic polyester where at least one of R₅ or R is a cycloalkyl containing radical. The polyester is a condensation product where R₅ is the residue of an aryl, alkane or cycloalkane containing diol having 6 to 20 carbon atoms or chemical equivalent thereof, and R is the decarboxylated residue derived from an aryl, aliphatic or cycloalkane containing diacid of 6 to 20 carbon atoms or chemical equivalent thereof. The polyester resins are typically obtained through the condensation or ester interchange polymerization of the diol or diol equivalent component with the diacid or diacid chemical equivalent component.

The diacids meant to include carboxylic acids having two carboxyl groups each useful in the preparation of the polyester resins of the present invention are preferably aliphatic, aromatic, cycloaliphatic. Examples of diacids are cyclo or bicyclo aliphatic acids, for example, decahydro naphthalene dicarboxylic acids, norbornene dicarboxylic acids, bicyclo octane dicarboxylic acids, 1,4-cyclohexanedicarboxylic acid or chemical equivalents, and most preferred is trans-1,4-cyclohexanedicarboxylic acid or a chemical equivalent. Linear dicarboxylic acids like adipic acid, azelaic acid, dicarboxyl dodecanoic acid, and succinic acid may also be useful. Chemical equivalents of these diacids include esters, alkyl esters, e.g., dialkyl esters, diaryl esters, anhydrides, salts, acid chlorides, acid bromides, and the like. Examples of aromatic dicarboxylic acids from which the decarboxylated residue R may be derived are acids that contain a single aromatic ring per molecule such as, e.g., isophthalic or terephthalic acid, 1,2-di(p-carboxyphenyl)ethane, 4,4′-dicarboxydiphenyl ether, 4,4′-bisbenzoic acid and mixtures thereof, as well as acids contain fused rings such as, eg., 1,4- or 1,5-naphthalene dicarboxylic acids. In a preferred embodiment, the dicarboxylic acid precursor of residue R is terephthalic acid or, alternatively, a mixture of terephthalic and isophthalic acids.

Examples of the polyvalent carboxylic acid include, but are not limited to, an aromatic polyvalent carboxylic acid, an aromatic oxycarboxylic acid, an aliphatic dicarboxylic acid, and an alicyclic dicarboxylic acid, including terephthalic acid, isophthalic acid, ortho-phthalic acid, 1,5-naphthalenedicarboxyli acid, 2,6-naphthalenedicarboxylic acid, diphenic acid, sulfoterephthalic acid, 5-sulfoisophthalic acid, 4-sulfophthalic acid, 4-sulfonaphthalene 2,7-dicarboxylic acid, 5-[4-sulfophenoxy]isophthalic acid, sulfoterephthalic acid, p-oxybenzoic acid, p-(hydroxyethoxy)benzoic acid, succinic acid, adipic acid, azelaic acid, sebacic acid, dodecanedicarboxylic acid, fumaric acid, maleic acid, itaconic acid, hexahydrophthalic acid, tetrahydrophthalic acid, trimellitic acid, trimesic acid, and pyrromellitic acid. These may be used in the form of metal salts and ammonium salts and the like.

Some of the diols useful in the preparation of the polyester resins of the present invention are straight chain, branched, or cycloaliphatic alkane diols and may contain from 2 to 12 carbon atoms. Examples of such diols include but are not limited to ethylene glycol; propylene glycol, i.e., 1,2- and 1,3-propylene glycol; 2,2-dimethyl-1,3-propane diol; 2-ethyl, 2-methyl, 1,3-propane diol; 1,3- and 1,5-pentane diol; dipropylene glycol; 2-methyl-1,5-pentane diol; 1,6-hexane diol; dimethanol decalin, dimethanol bicyclo octane; 1,4-cyclohexane dimethanol and particularly its cis- and trans-isomers; triethylene glycol; 1,10-decane diol; and mixtures of any of the foregoing. Preferably, a cycloaliphatic diol or chemical equivalent thereof and particularly 1,4-cyclohexane dimethanol or its chemical equivalents are used as the diol component. Chemical equivalents to the diols include esters, such as dialkylesters, diaryl esters, and the like.

Examples of the polyvalent alcohol include, but are not limited to, an aliphatic polyvalent alcohol, an alicyclic polyvalent alcohol, and an aromatic polyvalent alcohol, including ethylene glycol, propylene glycol, 1,3-propanediol, 2,3-butanediol, 1,4-butanediol, 1,5-pentanediol, 1,6-hexanediol, neopentyl glycol, diethylene glycol, dipropylene glycol, 2,2,4-trimethyl-1,3-pentanediol, polyethylene glycol, polypropylene glycol, polytetramethylene glycol, trimethylolethane, trimethylolpropane, glycerin, pentaerythritol, 1,4-cyclohexanediol, 1,4-cyclohexanedimethanol, spiroglycol, tricyclodecanediol, tricyclodecanedimethanol, m-xylene glycol, o-xylene glycol, 1,4-phenylene glycol, bisphenol A, lactone polyester and polyols. Further, with respect to the polyester resin obtained by polymerizing the polybasic carboxylic acids and the polyhydric alcohols either singly or in combination respectively, a resin obtained by capping the polar group in the end of the polymer chain using an ordinary compound capable of capping an end can also be used.

Typically the polyester resin may comprise one or more resins selected from linear polyester resins, branched polyester resins and copolymeric polyester resins. Suitable linear polyester resins include, e.g., poly(alkylene phthalate)s such as, e.g., poly(ethylene terephthalate) (“PET”), poly(butylene terephthalate) (“PBT”), poly(propylene terephthalate) (“PPT”), poly(cycloalkylene phthalate)s such as, e.g., poly(cyclohexanedimethanol terephthalate) (“PCT”), poly(alkylene naphthalate)s such as, e.g., poly(butylene-2,6-naphthalate) (“PBN”) and poly(ethylene-2,6-naphthalate) (“PEN”), poly(alkylene dicarboxylate)s such as, e.g., poly(butylene dicarboxylate).

The polyesters in one embodiment of the present invention may be a polyether ester block copolymer consisting of a thermoplastic polyester as the hard segment and a polyalkylene glycol as the soft segment. It may also be a threocomponent copolymer obtained from at least one dicarboxylic acid selected from: aromatic dicarboxylic acids such as terephthalic acid, isophthalic acid, phthalic acid, naphthalene-2,6-dicarboxylic acid, naphthalene-2,7-dicarboxylic acid, diphenyl-4,4-dicarboxylic acid, diphenoxyethanedicarboxylic acid or 3-sulfoisophthalic acid, alicyclic dicarboxylic acids such as 1,4-cyclohexanedicarboxylic acid, aliphatic dicarboxylic acids such as succinic acid, oxalic acid, adipic acid, sebacic acid, dodecanedicarboxylic acid or dimeric acid, and ester-forming derivatives thereof; at least one diol selected from: aliphatic diols such as 1,4-butanediol, ethylene glycol, trimethylene glycol, tetramethylene glycol, pentamethylene glycol, hexamethylene glycol, neopentyl glycol or decamethylene glycol, alicyclic diols such as 1,1-cyclohexanedimethanol, 1,4-cyclohexanedimethanol or tricyclodecanedimethanol, and ester-forming derivatives thereof; and at least one poly(alkylene oxide)glycol selected from: polyethylene glycol or poly(1,2- and 1,3-propylene oxide)glycol with an average molecular weight of about 400-5000, ethylene oxide-propylene oxide copolymer, and ethylene oxide-tetrahydrofuran copolymer.

In one embodiment of the present invention the polyester is an aliphatic polyester where at least one of R₅ or R is a cycloalkyl containing radical. In one embodiment at least one R₅ or R is cycloaliphatic. Preferred polyesters of the invention will have both R₅ and R cycloaliphatic. In one embodiment the present cycloaliphatic polyesters are condensation products of aliphatic diacids, or chemical equivalents and aliphatic diols, or chemical equivalents. The present cycloaliphatic polyesters may be formed from mixtures of aliphatic diacids and aliphatic diols but must contain at least 50 mol % of cyclic diacid and/or cyclic diol components, the remainder, if any, being linear aliphatic diacids and/or diols. The cyclic components are necessary to impart good rigidity to the polyester and to allow the formation of transparent blends due to favorable interaction with the polycarbonate resin.

R₅ and R are preferably cycloalkyl radicals independently selected from the following formula:

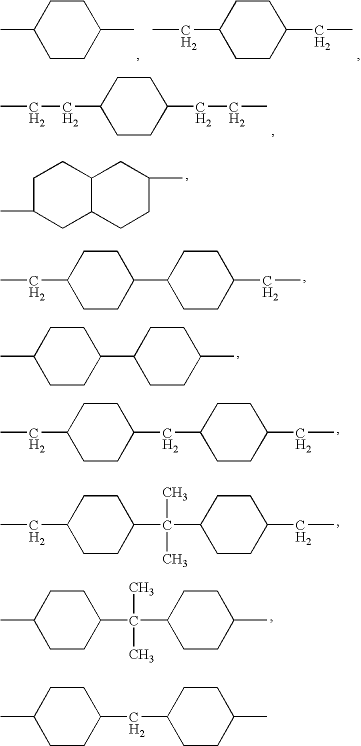

The preferred cycloaliphatic radical R is derived from the 1,4-cyclohexyl diacids and most preferably greater than 70 mol % thereof in the form of the trans isomer. The preferred cycloaliphatic radical is derived from the 1,4-cyclohexyl primary diols such as 1,4-cyclohexyl dimethanol, most preferably more than 70 mol % thereof in the form of the trans isomer.

Typically, in the hydrogenation, two isomers are obtained in which the carboxylic acid groups are in cis- or trans-positions. The cis and trans-isomers can be separated by crystallization with or without a solvent, for example, n-heptane, or by distillation. The cis-isomer tends to blend better; however, the trans-isomer has higher melting and crystallization temperatures and may be preferred. Mixtures of the cis- and trans-isomers are useful herein as well. When the mixture of isomers or more than one diacid or diol is used, a copolyester or a mixture of two polyesters may be used as the present cycloaliphatic polyester resin.

A preferred cycloaliphatic polyester is poly(cyclohexane-1,4-dimethylene cyclohexane-1,4-dicarboxylate) also referred to as poly(1,4-cyclohexane-dimethanol 1,4-dicarboxylate) (PCCD) which has recurring units of formula V:

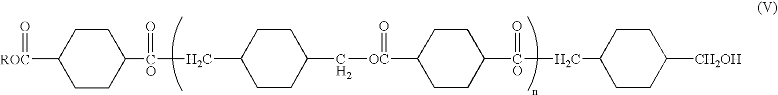

With reference to the previously set forth general formula, for PCCD, is derived from 1,4 cyclohexane dimethanol; and a cyclohexane ring derived from cyclohexanedicarboxylate or a chemical equivalent thereof. The favored PCCD has a cis/trans formula. In one embodiment R is an alkyl from 1 to 6 carbon atoms or residual endgroups derived from either monomer, and n is greater than about 70. The polyester is derived from the transesterification reaction of a starting DMCD and a starting CHDM. The trans-cis ratio of repeating units derived from DMCD is preferably greater than about 8 to 1, and the trans-cis ratio of repeating units derived from CHDM is preferable greater than about 1 to 1. The polyester resin typically a viscosity of about 2500 poise and a melting temperature greater than 216° C., and an acid number less than about 10, preferably less than about 6 meq/kg.

The linear PCCD polyester is prepared by the condensation reaction of CHDM and DMCD in the presence of a catalyst wherein the starting DMCD has a trans-cis ratio greater than the equilibrium trans-cis ratio. The resulting prepared PCCD polyester has a trans-cis ratio of repeating polymer units derived from the respective starting DMCD which has a trans-cis ratio substantially equal to the respective starting trans-cis ratio for enhancing the crystallinity of the resulting PCCD.

The starting DMCD typically has a trans-cis ratio greater than about 6 to 1, preferably greater than 9 to 1, and even more preferably greater than 19 to 1. In the resulting PCCD, it is preferable that less than about 10 percent the starting tans DMCD, and more preferable that less than about 5 percent of the starting trans DMCD be converted to the cis isomer during the reaction of CHDM and DMCD to produce PCCD. The trans:cis ratio of the CHDM is preferable greater than 1 to 1, and more preferably greater than about 2 to 1.

The resulting linear PCCD polymer is characterized by the absence of branching. During the reaction process, branching may be induced by the addition of polyglycol and such branching agents as trimellitic acid or anhydride, trimesic acid, trimethyiolethane, trimethylolpropane, or a trimer acid. The use of such branching agents is not desirable according to the present invention.

Preferably the amount of catalyst present is less than about 200 ppm. Typically, catalyst may be present in a range from about 20 to about 300 ppm. The most preferred materials are blends where the polyester has both cycloaliphatic diacid and cycloaliphatic diol components specifically polycyclohexane dimethanol cyclohexyl dicarboxylate (PCCD).

In one embodiment the above polyesters with from about 1 to about 50% by weight, of units derived from polymeric aliphatic acids and/or polymeric aliphatic polyols to form copolyesters. The aliphatic polyols include glycols, such as poly(ethylene glycol) or poly(butylene glycol). In another embodiment suitable copolymeric polyester resins include, e.g., polyesteramide copolymers, cyclohexanedimethanol-terephthalic acid-isophthalic acid copolymers and cyclohexanedimethanol-terephthalic acid-ethylene glycol (“PCTG”) copolymers. The polyester component may be prepared by procedures well known to those skilled in this art, such as by condensation reactions. The condensation reaction may be facilitated by the use of a catalyst, with the choice of catalyst being determined by the nature of the reactants. The various catalysts for use herein are very well known in the art and are too numerous to mention individually herein. Generally, however, when an alkyl ester of the dicarboxylic acid compound is employed, an ester interchange type of catalyst is preferred, such as Ti(OC₄H₉)₆ in n-butanol in a suitable amount, typically about 50 ppm to about 200 ppm of titanium based upon the final product.

The preferred polyesters are preferably low molecular weight polyester polymers have an intrinsic viscosity (as measured in 60:40 solvent mixture of phenol/tetrachloroethane at 25° C.) ranging from about 0.1 to about 0.5 deciliters per gram. Polyesters branched or unbranched and generally will have a weight average molecular weight of from about 5,000 to about 1,00,000, preferably from about 8,000 to about 95,000 as measured by viscosity measurements in Phenol/tetrachloroethane (60:40, volume/volume ratio) solvent mixture. It is contemplated that the polyesters have various known end groups.

In one embodiment of the present invention the copolyesters are prepared by melt processes that are well known to those skilled in the art and consist of several steps. The first reaction step is generally done under a nitrogen sweep with efficient stirring and the reactants may be heated slowly or quickly. Appropriate reaction conditions for a variety of acid-glycol polymerizations are known in the art. Any polymerization temperature which gives a clear melt under the addition conditions and affords a reasonable rate of polymerization without unwanted amount of side reaction and degradation may be used. In one embodiment the temperature of the reaction is between about 175° C. and about 350° C. In another embodiment the temperature is between about 200° C. and about 300_° C. The reaction is maintained in this stage for 0.5 to 3 hours with the condensation reaction of amidation and esterification taking place. In one embodiment the reaction is then carried out under vacuum of about 0.1 Torr while the reaction occurs and copolyester of desired molecular weight is built. In one embodiment the copolyester is recovered in the last step by either cooling and isolating the polymer and grinding or by extruding the hot polymer melt, cooling and pelletizing.

In one embodiment the catalysts include, but are not limited to metal salts and chelates of Ti, Zn, Ge, Ga, Sn, Ca, Li and Sb. Other known catalysts may also be used for this step-growth polymerization. Examples of the esterification catalysts, which may be employed in the above melt reaction process include titanium alkoxides such as tetramethyl, tetraethyl, tetra(n-propyl), tetraisopropyl and tetrabutyl titanates; dialkyl tin compounds, such as di-(n-butyl)tin dilaurate. di-(n-butyl)tin oxide and di-(n-butyl)tin diacetate; and oxides. acetate salts and sulfate salts of metals, such as magnesium, calcium, germanium, zinc, antimony, etc. Conveniently titanium alkoxides are employed. The catalyst level is employed in an effective amount to enable the copolymer formation and is not critical and is dependent on the catalyst that is used. Generally the catalyst is used in concentration ranges of about 10 to about 500 ppm, preferably about 20 to about 4500 ppm and most preferably about 50 to about 400 ppm.

The ratio of reactants in these polymerizations is important. In one embodiment of the present invention the amount of diol is maintained constant and the ratio of diester to diimide of the present invention is varied. In one embodiment the amount of diol is 100 mole percent. The amount of diacid is in the range between about 70 mole percent and about 99 mole percent. In another embodiment the amount of diacid or diester is in the range between about 75 mole percent and about 95 mole percent. In another embodiment the amount of diimide compound that is added is between about 30 mole percent and about 1 mole percent. In an alternate embodiment the amount of diimide is between about 5 mole percent and about 25 mole percent.

The ratio of reactants in these polymerizations is important. In one embodiment of the present invention the amount of diacid or diester is maintained constant and the ratio of diol to diimide of the present invention is varied. In one embodiment the amount of diacid/diester is 100 mole percent. The amount of diol is in the range between about 70 mole percent and about 99 mole percent. In another embodiment the amount of diol is in the range between about 75 mole percent and about 95 mole percent. In another embodiment the amount of diimide compound that is added is between about 30 mole percent and about I mole percent. In an alternate embodiment the amount of diimide is between about 5 mole percent and about 25 mole percent.

The reaction may be conducted optionally in presence of a solvent or in neat conditions without the solvent. The organic solvent used in the above process according to the invention should be capable of dissolving the diimide, the copolymer resulting from the reactions between the diimide, diol, and diacid or diester to an extent of at least 0.01 g/per ml at 25° C. and should have a boiling point in the range of 140-290° C. at atmospheric pressure. Preferred examples of the solvent include but are not limited to amide solvents, in particular, N-methyl-2-pyrrolidone; N-acetyl2-pyrrolidone; N,N′-dimethyl formamide; N,N′-dimethyl acetamide; N,N′-diethyl acetamide; N,N′-dimethyl propionic acid amide; N,N′-diethyl propionic acid amide; tetramethyl urea; tetraethyl urea; hexamethylphosphor triamide; N-methyl caprolactam and the like. Other solvents may also be employed, for example, methylene chloride, chloroform, 1,2-dichloroethane, tetrahydrofuran, diethyl ether, dioxane, benzene, toluene, chlorobenzene, o-dichlorobenzene and the like.

In one embodiment the glass transition temperatures (T_{g}) of the copolyesters that are substiatially higher than the homopolyesters. The copolyesters of the present invention have a glass transition temperature in the range of between about 65° C. and about 250° C. In one embodiment of the present invention the glass transition temperature and the melting temperature is dependent on the amount of diimide in the copolymer. In one embodiment with increase in amount of esteramide while an increase in glass transition is observed. Preferably, the number average molecular weight of the esteramide copolymer ranges from about 5,000 to about 500,000. If the number average molecular weight is less than about 5,000, the copolymer product shows poor mechanical properties.

In one embodiment of the present invention a thermoplastic resin composition (also known as “copolyester blend”) is disclosed wherein the composition comprises structural units derived from the copolymer of the present invention and substituted or unsubstituted polymer resin. Examples of materials suitable for use as the polymer resin include, but are not limited to, amorphous, crystalline, and semicrystalline thermoplastic materials such as: polyvinyl chloride, polyolefins (including, but not limited to, linear and cyclic polyolefins and including polyethylene, chlorinated polyethylene, polypropylene, and the like), polyesters (including, but not limited to, polyethylene terephthalate, polybutylene terephthalate, polycyclohexylmethylene terephthalate, and the like), polyamides, polysulfones (including, but not limited to, hydrogenated polysulfones, and the like), polyimides, polyether imides, polyether sulfones, polyphenylene sulfides, polyether ketones, polyether ether ketones, ABS resins, polystyrenes (including, but not limited to, hydrogenated polystyrenes, syndiotactic and atactic polystyrenes, polycyclohexyl ethylene, styrene-co-acrylonitrile, styrene-co-maleic anhydride, and the like), polybutadiene, polyacrylates (including, but not limited to, polymethylmethacrylate (PMMA), methyl methacrylate-polyimide copolymers, and the like), polyacrylonitrile, polyacetals, polycarbonates, polyphenylene ethers (including, but not limited to, those derived from 2,6-dimethylphenol and copolymers with 2,3,6-trimethylphenol, and the like), ethylene-vinyl acetate copolymers, polyvinyl acetate, liquid crystal polymers, ethylene-tetrafluoroethylene copolymer, aromatic polyesters, polyvinyl fluoride, polyvinylidene fluoride, polyvinylidene chloride, and tetrafluoroethylenes (e.g., Teflons) and mixtures, copolymers, reaction products, blends and composites comprising at least one of the foregoing polymers. In one embodiment, the polymer resin can be homopolymers or copolymers of one of polyolefins, polycarbonates, polyesters, polyphenylene ethers and styrenic polymers, or a mixture thereof. In another embodiment the polymer resin comprises a polyolefin selected from the group consisting of polyethylene, polypropylene, polybutylene, homopolymers, copolymers and mixtures thereof. In yet another embodiment of the present invention the polymer resin comprises polycarbonate and mixtures, copolymers, reaction products, blends and composites comprising polycarbonate.

A component of the blend of the invention is an aromatic polycarbonate. The aromatic polycarbonate resins suitable for use in the present invention, methods of making polycarbonate resins and the use of polycarbonate resins in thermoplastic molding compounds are well known in the art, see, generally, U.S. Pat. Nos. 3,169,121, 4,487,896 and 5,411,999, the respective disclosures of which are each incorporated herein by reference.

Polycarbonates useful in the invention are preferably represented by the general formula: 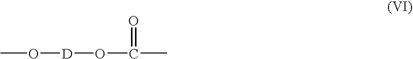
wherein R¹ is a divalent aromatic radical derived from a dihydroxyaromatic compound of the formula HO-D-OH, wherein D has the structure of formula: 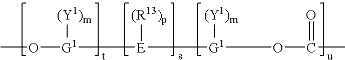
wherein G¹ represents an aromatic group, such as phenylene, biphenylene, naphthylene, and the like aromatic groups. In some embodiments E may be an alkylene or alkylidene group including, but not limited to, methylene, ethylene, ethylidene, propylene, propylidene, isopropylidene, butylene, butylidene, isobutylidene, amylene, amylidene, isoamylidene, and the like. In other embodiments when E is an alkylene or alkylidene group, it may also consist of two or more alkylene or alkylidene groups connected by a moiety different from alkylene or alkylidene, including, but not limited to, an aromatic linkage; a tertiary nitrogen linkage; an ether linkage; a carbonyl linkage; a silicon-containing linkage, silane, siloxy; or a sulfur-containing linkage including, but not limited to, sulfide, sulfoxide, sulfone, and the like; or a phosphorus-containing linkage including, but not limited to, phosphinyl, phosphonyl, and the like. In other embodiments E may be a cycloaliphatic group including, but not limited to, cyclopentylidene, cyclohexylidene, 3,3,5-trimethylcyclohexylidene, methylcyclohexylidene, 2-[2.2.1]-bicycloheptylidene, neopentylidene, cyclopentadecylidene, cyclododecylidene, adamantylidene, and the like; a sulfur-containing linkage, including, but not limited to, sulfide, sulfoxide or sulfone; a phosphorus-containing linkage, including, but not limited to, phosphinyl or phosphonyl; an ether linkage; a carbonyl group; a tertiary nitrogen group; or a silicon-containing linkage including, but not limited to, silane or siloxy. R¹³ independently at each occurrence comprises a monovalent hydrocarbon group including, but not limited to, alkenyl, allyl, alkyl, aryl, aralkyl, alkaryl, or cycloalkyl. In various embodiments a monovalent hydrocarbon group of R¹³ may be halogen-substituted, particularly fluoro- or chloro-substituted, for example as in dichloroalkylidene, particularly gem-dichloroalkylidene. Y¹ independently at each occurrence may be an inorganic atom including, but not limited to, halogen (fluorine, bromine, chlorine, iodine); an inorganic group containing more than one inorganic atom including, but not limited to, nitro; an organic group including, but not limited to, a monovalent hydrocarbon group including, but not limited to, alkenyl, allyl, alkyl, aryl, aralkyl, alkaryl, or cycloalkyl, or an oxy group including, but not limited to, OR¹⁴ wherein R¹⁵ is a monovalent hydrocarbon group including, but not limited to, alkyl, aryl, aralkyl, alkaryl, or cycloalkyl. In a preferred embodiment, Y¹ is inert to and unaffected by the reactants and reaction conditions used to prepare the polymer. In some particular embodiments Y¹ comprises a halo group or C₁-C₆ alkyl group. The letter “m” represents any integer from and including zero through the number of positions on G¹ available for substitution; “p” represents an integer from and including zero through the number of positions on E available for substitution; “t” represents an integer equal to at least one; “s” is either zero or one; and “u” represents any integer including zero. These polycarbonates can be produced by any technique as described in the U.S. Pat. Nos. 5,484,875; 6,506,871, 6,518,319 and U.S. patent application 20030149223, or any other technique well known in the art. The molecular weight of the polycarbonate product may be manipulated by controlling, among other factors, the feed rate of the reactants, the type of extruder, the extruder screw design and configuration, the residence time in the extruder, the reaction temperature and the pressure reducing techniques present on the extruder. The molecular weight of the polycarbonate product may also depend upon the structures of the reactants, such as, activated aromatic carbonate, aliphatic diol, dihydroxy aromatic compound, and the catalyst employed.

In dihydroxy-substituted aromatic hydrocarbons in which D is represented by formula (VII) above, when more than one Y¹ substituent is present, they may be the same or different. The same holds true for the R¹³ substituent. Where “s” is zero in formula (VII) and “u” is not zero, the aromatic rings are directly joined by a covalent bond with no intervening alkylidene or other bridge. The positions of the hydroxyl groups and Y¹ on the aromatic nuclear residues G¹ can be varied in the ortho, meta, or para positions and the groupings can be in vicinal, asymmetrical or symmetrical relationship, where two or more ring carbon atoms of the hydrocarbon residue are substituted with Y¹ and hydroxyl groups. In some particular embodiments the parameters “t”, “s”, and “u” each have the value of one; both G¹ radicals are unsubstituted phenylene radicals; and E is an alkylidene group such as isopropylidene. In some particular embodiments both G¹ radicals are p-phenylene, although both may be o- or m-phenylene or one o- or m-phenylene and the other p-phenylene.

In some embodiments of dihydroxy-substituted aromatic hydrocarbons E may be an unsaturated alkylidene group. Suitable dihydroxy-substituted aromatic hydrocarbons of this type include those of the formula (VIII): 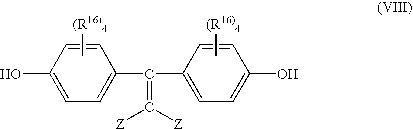
where independently each R¹⁶ is hydrogen, chlorine, bromine or a C₁₋₃₀ monovalent hydrocarbon or hydrocarbon-oxy group, each Z is hydrogen, chlorine or bromine, subject to the provision that at least one Z is chlorine or bromine.

Suitable dihydroxy-substituted aromatic hydrocarbons also include those of the formula (IX): 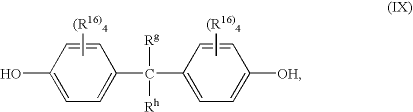
where independently each R16 is as defined hereinbefore, and independently Rg and Rh are hydrogen or a C1-30 hydrocarbon group.

In some embodiments of the present invention, dihydroxy-substituted aromatic hydrocarbons that may be used comprise those disclosed by name or formula (generic or specific) in U.S. Pat. Nos. 2,991,273, 2,999,835, 3,028,365, 3,148,172, 3,153,008, 3,271,367, 3,271,368, and 4,217,438. In other embodiments of the invention, dihydroxy-substituted aromatic hydrocarbons comprise bis(4-hydroxyphenyl)sulfide, bis(4-hydroxyphenyl)ether, bis(4-hydroxyphenyl)sulfone, bis(4-hydroxyphenyl)sulfoxide, 1,4-dihydroxybenzene, 4,4′-oxydiphenol, 2,2-bis(4-hydroxyphenyl)hexafluoropropane, 4,4′-(3,3,5-trimethylcyclohexylidene)diphenol; 4,4′-bis(3,5-dimethyl)diphenol, 1,1-bis(4-hydroxy-3-methylphenyl)cyclohexane; 4,4-bis(4-hydroxyphenyl)heptane; 2,4′-dihydroxydiphenylmethane; bis(2-hydroxyphenyl)methane; bis(4-hydroxyphenyl)methane; bis(4-hydroxy-5-nitrophenyl)methane; bis(4-hydroxy-2,6-dimethyl-3-methoxyphenyl)methane; 1,1-bis(4-hydroxyphenyl)ethane; 1,2-bis(4-hydroxyphenyl)ethane; 1,1-bis(4-hydroxy-2-chlorophenyl)ethane; 2,2-bis(3-phenyl-4-hydroxyphenyl)propane; 2,2-bis(4-hydroxy-3-methylphenyl)propane; 2,2-bis(4-hydroxy-3-ethylphenyl)propane; 2,2-bis(4-hydroxy-3-isopropylphenyl)propane; 2,2-bis(4-hydroxy-3,5-dimethylphenyl)propane; 3,5,3′,5′-tetrachloro-4,4′-dihydroxyphenyl)propane; bis(4-hydroxyphenyl)cyclohexylmethane; 2,2-bis(4-hydroxyphenyl)-1-phenylpropane; 2,4′-dihydroxyphenyl sulfone; dihydroxy naphthalene; 2,6-dihydroxy naphthalene; hydroquinone; resorcinol; C1-3 alkyl-substituted resorcinols; methyl resorcinol, catechol, 1,4-dihydroxy-3-methylbenzene; 2,2-bis(4-hydroxyphenyl)butane; 2,2-bis(4-hydroxyphenyl)-2-methylbutane; 1,1-bis(4-hydroxyphenyl)cyclohexane; 4,4′-dihydroxydiphenyl; 2-(3-methyl-4-hydroxyphenyl-2-(4-hydroxyphenyl)propane; 2-(3,5-dimethyl-4-hydroxyphenyl)-2-(4-hydroxyphenyl)propane; 2-(3-methyl-4-hydroxyphenyl)-2-(3,5-dimethyl-4-hydroxyphenyl)propane; bis(3,5-dimethylphenyl-4-hydroxyphenyl)methane; 1,1-bis(3,5-dimethylphenyl-4-hydroxyphenyl)ethane; 2,2-bis(3,5-dimethylphenyl-4-hydroxyphenyl)propane; 2,4-bis(3,5-dimethylphenyl-4-hydroxyphenyl)-2-methylbutane; 3,3-bis(3,5-dimethylphenyl-4-hydroxyphenyl)pentane; 1,1-bis(3,5-dimethylphenyl-4-hydroxyphenyl)cyclopentane; 1,1-bis(3,5-dimethylphenyl-4-hydroxyphenyl)cyclohexane; bis(3,5-dimethyl-4-hydroxyphenyl)sulfoxide, bis(3,5-dimethyl-4-hydroxyphenyl)sulfone and bis(3,5-dimethylphenyl-4-hydroxyphenyl)sulfide. In a particular embodiment the dihydroxy-substituted aromatic hydrocarbon comprises bisphenol A.

In some embodiments of dihydroxy-substituted aromatic hydrocarbons when E is an alkylene or alkylidene group, said group may be part of one or more fused rings attached to one or more aromatic groups bearing one hydroxy substituent. Suitable dihydroxy-substituted aromatic hydrocarbons of this type include those containing indane structural units such as represented by the formula (X), which compound is 3-(4-hydroxyphenyl)-1,1,3-trimethylindan-5-ol, and by the formula (XI), which compound is 1-(4-hydroxyphenyl)-1,3,3-trimethylindan-5-ol:

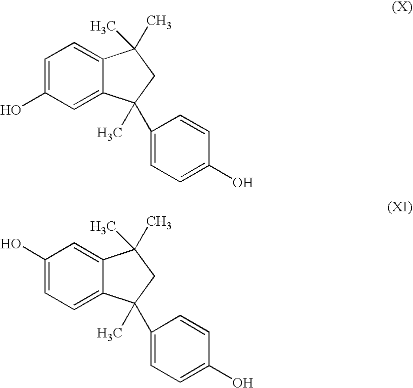

Also included among suitable dihydroxy-substituted aromatic hydrocarbons of the type comprising one or more alkylene or alkylidene groups as part of fused rings are the 2,2,2′,2′-tetrahydro-1,1′-spirobi[1H-indene]diols having formula (XII): 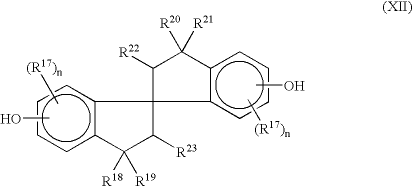
wherein each R¹⁷ is independently selected from monovalent hydrocarbon radicals and halogen radicals; each R¹⁸, R¹⁹, R²⁰, and R²¹ is independently C1-6 alkyl; each R²² and R²³ is independently H or C1-6 alkyl; and each n is independently selected from positive integers having a value of from 0 to 3 inclusive. In a particular embodiment the 2,2,2′,2′-tetrahydro-1,1′-spirobi[1H-indene]diol is 2,2,2′,2′-tetrahydro-3,3,3′,3′-tetramethyl-1,1′-spirobi[1H-indene]-6,6′-diol (sometimes known as “SBI”). Mixtures of alkali metal salts derived from mixtures of any of the foregoing dihydroxy-substituted aromatic hydrocarbons may also be employed.

The term “alkyl” as used in the various embodiments of the present invention is intended to designate both linear alkyl, branched alkyl, aralkyl, cycloalkyl, bicycloalkyl, tricycloalkyl and polycycloalkyl radicals containing carbon and hydrogen atoms, and optionally containing atoms in addition to carbon and hydrogen, for example atoms selected from Groups 15, 16 and 17 of the Periodic Table. The term “alkyl” also encompasses that alkyl portion of alkoxide groups. In various embodiments normal and branched alkyl radicals are those containing from 1 to about 32 carbon atoms, and include as illustrative non-limiting examples C1-C32 alkyl optionally substituted with one or more groups selected from C1-C32 alkyl, C3-C15 cycloalkyl or aryl; and C3-C15 cycloalkyl optionally substituted with one or more groups selected from C1-C32 alkyl. Some particular illustrative examples comprise methyl, ethyl, n-propyl, isopropyl, n-butyl, sec-butyl, tertiary-butyl, pentyl, neopentyl, hexyl, heptyl, octyl, nonyl, decyl, undecyl and dodecyl. Some illustrative non-limiting examples of cycloalkyl and bicycloalkyl radicals include cyclobutyl, cyclopentyl, cyclohexyl, methylcyclohexyl, cycloheptyl, bicycloheptyl and adamantyl. In various embodiments aralkyl radicals are those containing from 7 to about 14 carbon atoms; these include, but are not limited to, benzyl, phenylbutyl, phenylpropyl, and phenylethyl. In various embodiments aryl radicals used in the various embodiments of the present invention are those substituted or unsubstituted aryl radicals containing from 6 to 18 ring carbon atoms. Some illustrative non-limiting examples of these aryl radicals include C6-C15 aryl optionally substituted with one or more groups selected from C1-C32 alkyl, C3-C15 cycloalkyl or aryl. Some particular illustrative examples of aryl radicals comprise substituted or unsubstituted phenyl, biphenyl, toluyl and naphthyl.

Mixtures comprising two or more hydroxy-substituted hydrocarbons may also be employed. In some particular embodiments mixtures of at least two monohydroxy-substituted alkyl hydrocarbons, or mixtures of at least one monohydroxy-substituted alkyl hydrocarbon and at least one dihydroxy-substituted alkyl hydrocarbon, or mixtures of at least two dihydroxy-substituted alkyl hydrocarbons, or mixtures of at least two monohydroxy-substituted aromatic hydrocarbons, or mixtures of at least two dihydroxy-substituted aromatic hydrocarbons, or mixtures of at least one monohydroxy-substituted aromatic hydrocarbon and at least one dihydroxy-substituted aromatic hydrocarbon, or mixtures of at least one monohydroxy-substituted alkyl hydrocarbon and at least one dihydroxy-substituted aromatic hydrocarbon may be employed.

In yet another, the polycarbonate resin is a linear polycarbonate resin that is derived from bisphenol A and phosgene. In an alternative embodiment, the polycarbonate resin is a blend of two or more polycarbonate resins.

The aromatic polycarbonate may be prepared in the melt, in solution, or by interfacial polymerization techniques well known in the art. For example, the aromatic polycarbonates can be made by reacting bisphenol-A with phosgene, dibutyl carbonate or diphenyl carbonate. Such aromatic polycarbonates are also commercially available. In one embodiment, the aromatic polycarbonate resins are commercially available from General Electric Company, e.g., LEXAN™ bisphenol A-type polycarbonate resins.

The preferred polycarbonates are preferably high molecular weight aromatic carbonate polymers have an intrinsic viscosity (as measured in methylene chloride at 25° C.) ranging from about 0.30 to about 1.00. deciliters per gram. Polycarbonates may be branched or unbranched and generally will have a weight average molecular weight of from about 10,000 to about 200,000, preferably from about 20,000 to about 100,000 as measured by gel permeation chromatography. It is contemplated that the polycarbonate may have various known end groups.

The synthesis of copolyester blends requires the presence of a catalyst to facilitate the formation of the blend. Generally, the transesterification catalyst (or mixture of catalysts) is added in very small amount (ppm level) during the melt mixing of polycarbonate and polyesters to promote the ester-carbonate exchange reactions. The catalyst employed are compounds of alkaline earth metal oxides such as magnesium oxides, calcium oxide, barium oxide and zinc oxide; alkali and alkaline earth metal salts; a Lewis catalyst such as tin or titanium compounds; a nitrogen-containing basic compound and the like. In one embodiment the catalysts present in an amount in the range of between about 5 to about 500 parts per million. However, the presence of excess catalyst leads to yellowing or color formation and the blends therefore become less transparent. Quenchers for example compounds like phosphoric acids, are typically added to the blends during the extrusion process to quench the excess catalyst and render the blends transparent. In one embodiment of the present invention additional catalyst or quencher are not added while the thermoplastic resin is being synthesized. In another embodiment of the present invention, the residual catalyst that is present in the polyester component is activated to enhance the ester-carbonate interchange reactions in reactive blending.

The composition of the present invention may include additional components which do not interfere with the previously mentioned desirable properties but enhance other favorable properties such as anti-oxidants, flame retardants, reinforcing materials, colorants, mold release agents, fillers, nucleating agents, UV light and heat stabilizers, lubricants, and the like. Additionally, additives such as antioxidants, minerals such as talc, clay, mica, barite, wollastonite and other stabilizers including but not limited to UV stabilizers, such as benzotriazole, supplemental reinforcing fillers such as flaked or milled glass, and the like, flame retardants, pigments or combinations thereof may be added to the compositions of the present invention.

Flame-retardant additives are desirably present in an amount at least sufficient to reduce the flammability of the polyester resin, preferably to a UL94 V-0 rating. The amount will vary with the nature of the resin and with the efficiency of the additive. In general, however, the amount of additive will be from 1 to 30 percent by weight based on the weight of resin. A preferred range will be from about 5 to 20 percent.

Typically halogenated aromatic flame-retardants include tetrabromobisphenol A polycarbonate oligomer, polybromophenyl ether, brominated polystyrene, brominated BPA polyepoxide, brominated imides, brominated polycarbonate, poly(haloaryl acrylate), poly(haloaryl methacrylate), or mixtures thereof. Examples of other suitable flame retardants are brominated polystyrenes such as polydibromostyrene and polytribromostyrene, decabromobiphenyl ethane, tetrabromobiphenyl, brominated alpha, omega -alkylene-bis-phthalimides, e.g. N,N′-ethylene-bis-tetrabromophthalimide, oligomeric brominated carbonates, especially carbonates derived from tetrabromobisphenol A, which, if desired, are end-capped with phenoxy radicals, or with brominated phenoxy radicals, or brominated epoxy resins.

The flame retardants are typically used with a synergist, particularly inorganic antimony compounds. Such compounds are widely available or can be made in known ways. Typical, inorganic synergist compounds include Sb₂O₅, SbS₃, sodium antimonate and the like. Especially preferred is antimony trioxide (Sb₂O₃). Synergists such as antimony oxides, are typically used at about 0.1 to 10 by weight based on the weight percent of resin in the final composition. Also, the final composition may contain polytetrafluoroethylene (PTFE) type resins or copolymers used to reduce dripping in flame retardant thermoplastics.

Also halogen-free flame retardants can be used. Typical flame-retardants are P-based flame retardants as organic phosphates (e.g. P(═O)(OR1)(OR2)(OR3) etc), phosphonates (e.g. R—P(═O)(OR1)(OR2) etc), phosphinates (e.g. R1,R2-P(═O)(OR3) etc, phosphine oxides (e.g. R1,R2,R3-P(═O) etc) as well as the corresponding phosphate, phosphonate and/or phosphinate salts of these P-compounds. Besides P-based flame retardants also N-containing compounds can be used like triazine derivatives as melamine cyanurate, melamine (pyro or poly)phosphates, melam, melem etc. Also other compounds as Zn-borates, hydroxides or carbonates as Mg— and/or Al-hydroxides or carbonates, Si-based compounds like silanes or siloxanes, Sulfur based compounds as aryl sulphonates (including salts of it) or sulphoxides, Sn-compounds as stannates can be used as well often in combination with one or more of the other possible flame retardants.

Other additional ingredients may include antioxidants, and UV absorbers, and other stabilizers. Antioxidants include i) alkylated monophenols, for example: 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(alpha-methylcyclohexyl)-4,6 dimethylphenol, 2,6-di-octadecyl-4-methylphenol, 2,4,6,-tricyclohexyphenol, 2,6-di-tert-butyl-4-methoxymethylphenol; ii) alkylated hydroquinones, for example, 2,6-di-tert-butyl-4-methoxyphenol, 2,5-di-tert-butyl-hydroquinone, 2,5-di-tert-amyl-hydroquinone, 2,6-diphenyl-4-octadecyloxyphenol; iii) hydroxylated thiodiphenyl ethers; iv) alkylidene-bisphenols; v) benzyl compounds, for example, 1,3,5-tris(3,5-di-tert-butyl-4-hydroxybenzyl)-2,4,6-trimethylbenzene; vi) acylaminophenols, for example, 4-hydroxy-lauric acid anilide; vii) esters of beta-(3,5-di-tert-butyl-4-hydroxyphenol)-propionic acid with monohydric or polyhydric alcohols; viii) esters of beta-(5-tert-butyl-4-hydroxy-3-methylphenyl)-propionic acid with monohydric or polyhydric alcohols; vii) esters of beta-(5-tert-butyl-4-hydroxy-3-methylphenyl)propionic acid with mono-or polyhydric alcohols, e.g., with methanol, diethylene glycol, octadecanol, triethylene glycol, 1,6-hexanediol, pentaerythritol, neopentyl glycol, tris(hydroxyethyl)isocyanurate, thiodiethylene glycol, N,N-bis(hydroxyethyl)oxalic acid diamide. Typical, UV absorbers and light stabilizers include i) 2-(2′-hydroxyphenyl)-benzotriazoles, for example, the 5′methyl-,3′,5′-di-tert-butyl-,5′-tert-butyl-,5′(1,1,3,3-tetramethylbutyl)-,5-chloro-3′,5′-di-tert-butyl-,5-chloro-3′tert-butyl-5′methyl-,3′sec-butyl-5′tert-butyl-,4′-octoxy,3′,5′-ditert-amyl-3′,5′-bis-(alpha,alpha-dimethylbenzyl)-derivatives; ii) 2.2 2-Hydroxy-benzophenones, for example, the 4-hydroxy-4-methoxy-,4-octoxy,4-decloxy-,4-dodecyloxy-,4-benzyloxy,4,2′,4′-trihydroxy-and 2′hydroxy-4,4′-dimethoxy derivative, and iii) esters of substituted and unsubstituted benzoic acids for example, phenyl salicylate, 4-tert-butylphenyl-salicilate, octylphenyl salicylate, dibenzoylresorcinol, bis-(4tert-butylbenzoyl)-resorcinol, benzoylresorcinol, 2,4-di-tert-butyl-phenyl-3,5-di-tert-butyl-4-hydroxybenzoate and hexadecyl-3,5-di-tert-butyl-4-hydroxybenzoate. Phosphites and phosphonites stabilizers, for example, include triphenyl phosphite, diphenylalkyl phosphites, phenyldialkyl phosphites, tris(nonyl-phenyl)phosphite, trilauryl phosphite, trioctadecyl phosphite, distearyl pentaerythritol diphosphite, tris(2,4-di-tert-butylphenyl)phosphite, diisodecyl pentaerythritol diphosphite, bis(2,4di-tert-butylphenyl)pentaerythritol diphosphite tristearyl sorbitol triphosphite, and tetrakis(2,4-di-tert-butylphenyl)4,4′-biphenylene diphosphonite.

Dyes or pigments may be used to give a background coloration. Dyes are typically organic materials that are soluble in the resin matrix while pigments may be organic complexes or even inorganic compounds or complexes which are typically insoluble in the resin matrix. These organic dyes and pigments include the following classes and examples: furnace carbon black, titanium oxide, phthalocyanine blues or greens, anthraquinone dyes, scarlet 3b Lake, azo compounds and acid azo pigments, quinacridones, chromophthalocyanine pyrrols, halogenated phthalocyanines, quinolines, heterocyclic dyes, perinone dyes, anthracenedione dyes, thioxanthene dyes, parazolone dyes, polymethine pigments and others.

The range of composition of the thermoplastic resin of the present invention is from about 5 to 95 weight percent of the polymer resin component, 95 to about 5 percent by weight of the copolyester component. In one embodiment, the composition comprises about 25-75 weight percent polymer resin and 75-25 weight percent of the copolyester component.

The method of blending can be carried out by conventional techniques. The production of the compositions may utilize any of the blending operations known for the blending of thermoplastics, for example blending in a kneading machine such as a Banbury mixer or an extruder. To prepare the resin composition, the components may be mixed by any known methods. Typically, there are two distinct mixing steps: a premixing step and a melt mixing step. In the premixing step, the dry ingredients are mixed together. The premixing step is typically performed using a tumbler mixer or ribbon blender. However, if desired, the premix may be manufactured using a high shear mixer such as a Henschel mixer or similar high intensity device. The premixing step is typically followed by a melt mixing step in which the premix is melted and mixed again as a melt. Alternatively, the premixing step may be omitted, amd raw materials may be added directly into the feed section of a melt mixing device, preferably via multiple feeding systems. In the melt mixing step, the ingredients are typically melt kneaded in a single screw or twin screw extruder, a Banbury mixer, a two roll mill, or similar device. In one embodiment the blend synthesized by melt mixing process the pre mixing is carried out at a temperature range of between about 200° C. to about 375° C. The heating or melt mixing is typically carried out at a temperature range of about 250° C. to about 300° C.

In one embodiment of the present invention the thermoplastic composition could be prepared by solution method. The solution method involves dissolving all the ingredients in a common solvent (or) a mixture of solvents and either precipitation in a non-solvent or evaporating the solvent either at room temperature or a higher temperature of at least about 50° C. to about 80° C. In one embodiment, the polycarbonates and the polyester can be mixed with a relatively volatile solvent, preferably an organic solvent, which is substantially inert towards the polymer, and will not attack and adversely affect the polymer. Some suitable organic solvents include ethylene glycol diacetate, butoxyethanol, methoxypropanol, the lower alkanols, chloroform, acetone, methylene chloride, carbon tetrachloride, tetrahydrofuran, and the like. In one embodiment of the present invention the non solvent is at least one selected from the group consisting of mono alcohols such as ethanol, methanol, isopropanol, butanols and lower alcohols with C1 to about C12 carbon atoms. In one embodiment the solvent is chloroform.

The glass transition temperature of the preferred copolyester blend is from about 70° C. to about 160° C., more preferably from 75° C. to about 155° C. The composition of the present invention can be molded into useful articles by a variety of means by many different processes to provide useful molded products such as injection, extrusion, rotation, foam molding calender molding and blow molding and thermoforming, compaction, melt spinning form articles. The thermoplastic composition of the present invention has additional properties of good mechanical properties, color stability, oxidation resistance, good flame retardancy, good processability, i.e. short molding cycle times, thermal properties. The articles made from the composition of the present invention may be used widely for both opaque and transparent applications. Non limiting examples of the various articles that could be made from the thermoplasstic composition of the present invention include house ware objects such as food containers and bowls, home appliances, as well as films, electrical connectors, electrical devices, computers, building and construction, outdoor equipment, trucks and automobiles.

### EXAMPLES

Without further elaboration, it is believed that one skilled in the art can, using the description herein, utilize the present invention to its fullest extent. The following examples are included to provide additional guidance to those skilled in the art in practicing the claimed invention. The examples provided are merely representative of the work that contributes to the teaching of the present application. While only certain features of the invention have been illustrated and described herein, many modifications and changes will occur to those skilled in the art. Accordingly, these examples are not intended to limit the invention, as defined in the appended claims, in any manner.

In the following examples values for glass transition temperatures (T_{g}) were determined by differential scanning calorimetry (DSC) at a heating rate of 20° C. per minute. Viscosity average molecular weights was measured in Ubbelhode suspended viscometer in phenol/tetrachloroethane 60/40 volume by volume ratio of the solvent mixture at 25° C. in thermostated viscosity bath. The weight average molecular weight weights were obtained from Gel permeation chromatography using polystyrene standards and chloroform as eluent. Also the Yellow index or YI was measured on a Gardner Colorimeter model XL-835. The percentage transmission and haze were determined in accordance with test method ASTM D-1003. Thermal analysis method is used to calculate the char yield of the polymer. The polymer is analyzed by thermogravimetric analysis. In this method a know quantity of polymer sample is heated under nitrogen at a heating rate of 20° C. per min up to 800° C. The percent residue remained after heating the polymer up to 800° C. is taken as char yield.

### PREPARATION OF 2,2-BIS[4-3,4-DICARBOXYPHENOXY)PHENYL]PROPANE BIS(2-HYDROXYETHYL)IMIDE (BPA-EA)

### Example 1

A 500 milliliter three necked round bottom flask was equipped with a nitrogen inlet, a magnetic stir bar, and Dean-stark trap connected to water condenser. The flask was charged with 72.86 gram (0.139 mole) of bisphenol A dianhydride (BPA-DA), 17.82 gram (17.61 milliliter; 0.291 mole) (5 mole percent excess) of 2-amino-ethanol and 200 milliliter of ortho-dichlorobenzene (ODCB) and 100 milliliter of toluene. The reaction mixture was purged with nitrogen and heated slowly. The reaction temperature was maintained at 130-140° C. for about two and half hours initially and during this period water which was a by-product (5 milliliter) was collected azeotropically with toluene in the Dean-Stark trap. The temperature was the raised to 175° C. and the reaction was continued for 5 hours. On cooling to room temperature a faint brown viscous oil separated out from ortho-dichlorobenzene. The brown viscous oil was poured into petroleum ether (500-600 milliliter) and kept overnight at room temperature. The petroleum ether was decanted and the oily product was washed with petroleum ether. To this product, methanol (700-800 milliliter) was added and heated slowly to 65° C. when the product got dissolved in methanol and on cooling to room temperature it crystallized out as a solid. The product was collected by filtration under suction and dried in vacuum oven (80° C., 12 hour). The desired compound 2,2-bis[4-3,4-dicarboxy phenoxy)phenyl]propane bis (2-hydroxyethyl)imide (BPA-EA) was obtained that had melting point 157-158° C. The yield obtained was 80 percent. The purity of the compound formed was analyzed by high performance liquid chromatography (HPLC).

### PREPARATION OF 2,2-BIS[4-3,4-DICARBOXYPHENOXY)PHENYL]PROPANE-BIS(P-CARBOXYETHYLPHENYL)IMIDE (BPA-ET)

### Example 2

A 500 milliliter three necked round bottom flask was equipped with a nitrogen inlet, a magnetic stir bar, a water condenser and was charged with 72.86 gram (0.139 mole) of BPA dianhydride, 47.57 gram (0.287 mole) of 4-amino ethyl benzoate and 250 milliliter of dimethylforamide (DMF). The reaction mixture was purged with nitrogen and heated under reflux (130-145° C.) for two hours with stirring. It was cooled to room temperature and 27.17 milliliter (0.287 moles) of acetic anhydride was added. The reaction mixture was the refluxed for about two hours. On cooling to room temperature a white precipitate formed. The precipitate was filtered, rinsed with toluene and dried in vacuum. The product was stirred with hot toluene (200 milliliter), and on cooling to room temperature filtered under suction. The product obtained was again dried in vacuum oven at 100° C. and the desired compound 2,2-bis[4-3,4-dicarboxy phenoxy)phenyl]propane bis (p-carboxyethylphenyl)imide (BPA-Et) was obtained in about 70 percent yield with a melting point of 226-228° C.

### Example 3

The synthesis of 2,2-bis[43,4-dicarboxyphenoxy)phenyl]propane bis(p-carboxyethylphenyl)imide (BPA-Et) was carried out in a mixture of solvents namely dimethyl sulphoxide and toluene in the ratio of 2:1 using Dean-stark trap apparatus. The reaction mixture was refluxed and the water generated in the reaction was removed azeotropically. The reaction was continued till the about 5 milliliter of water was collected in the Dean-Stark trap. The mixture was cooled and the product was isolated by recrystallizing from toluene solvent with an yield of was 70%.

### Example 4

A 500 milliliter three necked round bottom flask equipped with a nitrogen inlet, a magnetic stir bar, and Dean-stark trap connected to a water condenser was charged with 72.86 gram (0.139 mole) of BPA dianhydride, 47.57 gram (0.287 mole) of 4-aminoethyl benzoate and 200 milliliter of orthodichlorobenzene (ODCB) and 100 milliliter of toluene. The reaction mixture was purged with nitrogen and was refluxed at a temperature of 130-140° C. with constant stirring till about 5 milliliter of water was collected in the trap. On cooling to room temperature a white precipitate formed that was filtered, rinsed with toluene and dried in a vacuum. The precipitate was stirred in 200 milliliter of hot toluene and on cooling to room temperature the precipitate was filtered. The precipitate obtained was dried in vacuum oven and the desired compound 2,2-bis[4-3,4-dicarboxy phenoxy)phenyl]propane bis(p-carboxyethylphenyl)imide was obtained in an yield of about 75 percent (85 gram) with a melting point of 226-228° C. The purity of the compound was anbalyzed by high performance liquid chromatography (HPLC).

Preparation of Copolymers

### Example 5-35

The copolymers were synthesized polymerization of the monomers in a cylindrical glass reactor equipped with side arm, a mechanical stirrer driven by an overhead stirring motor and a small side arm with stopcock. The monomers were taken in the reactor and the side arm was used to purge nitrogen gas and for applying vacuum. The reactor was evacuated and purged with nitrogen to remove the traces of oxygen and brought to atmospheric pressure. The reaction mixture was heated till a clear melt was obtained. The entire reaction was carried out under nitrogen with constant stirring at the rate of about 100 rotations per minute. The catalyst titanium (IV) isoproxide about 400 parts per million was added through the side arm and the reaction was allowed to proceed while methanol a byproduct was distilled through the side arm. The temperature of the melt was increased to about 250-280° C. while kept in nitrogen atmosphere under stirring conditions for a period of 1 hour. The pressure in the reactor was reduced in a step wise manner from 900 millimeter of mercury to 700, 500, 300, 100, 50, 25 10 millimeter at a temperature of 280° C. Vacuum of about 0.5 to 0.1 millibar was applied and the polymerization was continued for a period of about 45 to 60 minutes. After completion of the polymerization the pressure inside the reactor was brought to atmospheric pressure by purging the reaction mixture with nitrogen. The copolymer was collected as high tensile wires by applying the nitrogen gas pressure and breaking the nipple at the bottom of the reactor. The polymers were dissolved in chloroform for molecular weight determinations using gel permeation chromatograms and glass transition temperature (Tg), was determined using differential scanning calorimeter (DSC). The melt stability of the copolymers was determined by using a compression molted discs. The ratio of the various monomers employed for the synthesis of the copolyesters and the properties of the copolyesters are given in Tables 1-4.

In Tables 1 to 4 the abbreviations are defined as follows: DMCD=1,4-dimethyl cyclohexane dicarboxylate; CHDM=1,4-cyclohexane dimethanol; TCD=tircyclo-dimethanol; HNDC=hydrogenated 2,6-naphthalene dicarboxylate; DMT=dimethyl terephthalate; NDC=2,6-naphthalene dicarboxylate; Dianol=bis(2-hydroxyethoxy)bisphenol A; BPA-Et=Bisphenol A dianhydride-bis(N-phenyl4-ethyl benzoate); BPA-EA=bisphenol A dianhydride bis(2-hydroxy ethanolimide); TMCBD: tetramethyl butane diol; HBPA=hydrogenated bisphenol A; CHDA-DEDA: bis(4-carboethoxy)1,4-diphenyl cyclohexylamide; HNEA-DEDA=bis(4-carboethoxy)-2,6-diphenyl-decalylamide; TPA-DEDA=bis(4-carboethoxy)1,4-diphenyl terephthalamide

TABLE 1
Copolyesters containing the BPA-Et moiety

| | Monomers (mole %) | | | | | | | |
|---|---|---|---|---|---|---|---|---|
| | Diacid/diester | Diol | BPA-Et | M_{w}^{a} | Mₙ^{b} (g/mol) | M_{w}^{b} (g/mol) | M_{w}/Mₙ | T_{g}^{c} (° C.) |
| Ex. 5 | — | TCD(100) | 100 | 46400 | 20900 | 50600 | 2.42 | 184 |
| Ex. 6 | — | CHDM(100) | 100 | 29500 | 8800 | 21400 | 2.43 | 168 |
| Ex. 7 | — | Dianol(100) | 100 | 14335 | 5070 | 13312 | 2.62 | 127 |
| Ex. 8 | — | HBPA(100) | 100 | 16800 | 4900 | 12100 | 2.5 | 160 |
| Ex. 9 | — | TMCBD(100) | 100 | 11000 | 3100 | 6300 | 2.01 | 139 |
| Ex. 10 | DMCD(90) | CHDM(100) | 10 | 56800 | 23800 | 54800 | 2.3 | 96 |
| Ex. 11 | DMCD(85) | CHDM(100) | 15 | 57500 | 24300 | 76700 | 3.15 | 105 |
| Ex. 12 | DMCD(80) | CHDM(100) | 20 | 78200 | 28300 | 93300 | 3.3 | 118 |
| Ex. 13 | DMCD(75) | CHDM(100) | 25 | 54300 | 19500 | 54300 | 2.78 | 124 |
| Ex. 14 | DMCD(70) | CHDM(100) | 30 | 60100 | 22500 | 96600 | 4.28 | 140 |
| Ex. 15 | DMCD(40) | CHDM(100) | 60 | 23500 | 24311 | 13686 | 1.77 | 151 |
| Ex. 16 | CHDA-DEDA(10) | TCD(100) | 90 | 44500 | 18000 | 51300 | 2.84 | 185 |
| Ex. 17 | CHDA-DEDA(20) | TCD(100) | 80 | 46700 | 21500 | 62900 | 2.92 | 186 |
| Ex. 18 | HNEA-DEDA(10) | TCD(100) | 90 | 42000 | 17900 | 38600 | 2.15 | 188 |
| Ex. 19 | HNEA-DEDA(20) | TCD(100) | 80 | 49500 | 18800 | 41500 | 2.21 | 192 |
| Ex. 20 | HNDC(30) | TCD(100) | 70 | 41500 | 21000 | 51200 | 2.43 | 167 |
| Ex. 21 | | TCD/NDM(70/30) | 100 | 35102 | 16700 | 32900 | 1.96 | 183 |
| Ex. 22 | DEDA-HNDC(50) | TCD(100) | 50 | 24100 | 11000 | 17200 | 1.6 | 194 |
| Ex. 23 | DMT(70) | TMCBD(100) | 30 | 12800 | 3640 | 7700 | 2.1 | 145 |
| Ex. 24 | NDC(50) | TCD(100) | 50 | 31200 | 17900 | 36700 | 2.05 | 167 |
| Ex. 25 | TPA-DEDA(05) | TCD(100) | 95 | 29600 | 16500 | 35600 | 2.15 | 181 |

^{a}Viscosity average molecular weight in Phenol/TCE (60:40 v/v) solvent mixture.
^{b}GPC molecular weight in chloroform at 25° C. using polystyrene standards.
^{c}Determined by DSC at a heating rate of 20° C./min. under N₂.

TABLE 2
Copolyester containing BPA-Et

| | Monomers (mole %) | | | Transmission | Yellowness |
|---|---|---|---|---|---|
| | Diacid/diester | Diol | BPA-Et | (%) | Index (YI) |
| Ex. 5 | — | TRICYCLODECYL(100) | 100 | 92.34 | 3.235 |
| Ex. 18 | HNEA-DEDA(10) | TRICYCLODECYL(100) | 90 | 91.04 | 2.982 |
| Ex. 24 | NDC(50) | TCD(50) | 100 | 90.46 | 2.837 |
| Ex. 25 | TPA-DEDA(05) | TCD(100) | 95 | 89.04 | 3.884 |

TABLE 3
Copolyesters containing the BPA-EA moiety

| | Monomers (mole %) | | | | | | | |
|---|---|---|---|---|---|---|---|---|
| | Diacid/diester | Diol | BPA-EA | M_{w}^{a} | Mₙ^{b} (g/mol) | M_{w}^{b} (g/mol) | M_{w}/Mₙ | T_{g}^{c} (° C.) |
| Ex 26 | DMCD (100) | | 100 | 16500 | 9000 | 16400 | 1.83 | 121 |
| Ex 27 | HNDC(100) | | 100 | 18500 | 12920 | 23539 | 1.82 | 125 |
| Ex 28 | Tetralin diester(100) | | 100 | 17600 | 11700 | 19600 | 1.7 | 132 |
| Ex 29 | DMT(100) | | 100 | 16300 | 9460 | 17203 | 1.81 | 140 |
| Ex 30 | NDC(100) | | 100 | 22500 | 14200 | 25200 | 1.8 | 155 |
| Ex 31 | DMCD(100) | CHDM(85) | 15 | 44400 | 20700 | 51200 | 2.47 | 85 |
| Ex 32 | DMCD(100) | CHDM(70) | 30 | 37700 | 17700 | 37800 | 2.13 | 98 |
| Ex 33 | DMCD(100) | CHDM(50) | 50 | 37000 | 17100 | 40200 | 2.35 | 110 |
| Ex 34 | DMCD(100) | CHDM(30) | 70 | 21500 | 11100 | 22100 | 1.99 | 116 |
| Ex 35 | BPA-Et(100) | | 100 | 22800 | 11600 | 23000 | 1.99 | 172 |

^{a}Viscosity average molecular weight in Phenol/TCE (60:40; v/v) solvent mixture.
^{b}GPC molecular weight in chloroform at 25° C. using polystyrene standards.
^{c}Determined by DSC at a heating rate of 20° C./min. under N₂.

TABLE 4
Char yield data for the copolyester

| | Monomers (mole %) | | | Char Yield |
|---|---|---|---|---|
| | Diacid/diester | Diol | BPA-Et/BPA-EA | (%) |
| Ex. 10 | DMCD(70) | CHDM(100) | 30 | 19.90 |
| Ex. 30 | DMCD(100) | CHDM (70) | 30 | 12 |

The copolymers shown in Tables 1-4 are found to have a T_{g} in the range of about 80 and about 195° C. depending upon the monomers and the amount of monomers employed. Tables 1-4 show that as the proportion of the diimide compound increases the copolymers becomes more amorphous in nature with a decrease in its crystallinity. The increase in the amount of the diimide compound in the copolymer also reveals an increase in the T_{g} (Ex10-15 and Ex 31-34) as compared to the corresponding homopolymer obtained by reacting CHDM and DMCD (65° C.). The copolyesters of the present invention display a high char yield, which is indicative of inherent fire resistant properties. The copolymers with BPA-Et moiety is shown to form optically clear films with percent transmission of greater than about 80% and a yellowness index in the range of about 2.75 to about 4.25.

Preparation of Blends:

Examples 36-43. In the examples, blends were made with 75 weight percent of polycarbonate available from General Electric Company as Lexan® polycarbonate resin blended with the copolyester The blends of copolyester with polycarbonate were obtained by solvent cast method. In this method the know amounts of copolyester and polycarbonate were dissolved in chloroform solvent (50 ml) to form a homogeneous solution. The solution allowed to evaporate at room temperature. The films were dried in vacuum at moderate temperatures of about 50-60° C. for about 12 hours to ensure that all the solvent had evaporated. The glass transition temperature (T_{g}) of the blends prepared was recorded. The data is given in Table 5. The blends have a glass transition temperature in the range of about 100° C. to about 132° C. depending upon the composition of the blend.

TABLE 5
Blends of Polycarbonate with copolyesters.

| | Copolyester | PC | | | |
|---|---|---|---|---|---|
| | of Ex 11 | (mole | Blend T_{g} | Yellowness | Transmission |
| | (mole %) | %) | (° C.) | Index | (%) |
| Ex. 36 | 80 | 20 | 103.02 | ND | ND |
| Ex. 37 | 70 | 30 | 107.5 | ND | ND |
| Ex. 38 | 60 | 40 | 110.12 | 3.07 | 89.60 |
| Ex. 39 | 50 | 50 | 116.7 | 1.03 | 91.30 |
| Ex. 40 | 40 | 60 | 121.2 | 1.90 | 72.80 |
| Ex. 41 | 35 | 65 | 123.6 | 1.10 | 89.30 |
| Ex. 42 | 30 | 70 | 126.2 | ND | ND |
| Ex. 43 | 20 | 80 | 132.65 | 1.34 | 70.80 |

ND = Not determined.

The thermoplastic resin compositions shown in Table 5 with copolyesters with BPA-Et moiety is shown to form optically clear films with percent transmission of greater than about 70% and a yellowness index of less than about 3.

While the invention has been illustrated and described in typical embodiments, it is not intended to be limited to the details shown, since various modifications and substitutions can be made without departing in any way from the spirit of the present invention. As such, further modifications and equivalents of the invention herein disclosed may occur to persons skilled in the art using no more than routine experimentation, and all such modifications and equivalents are believed to be within the spirit and scope of the invention as defined-by the following claims. All Patents and published articles cited herein are incorporated herein by reference.

1. A copolymer composition comprising: structural units derived from a substituted or unsubstituted diacid or diester, a substituted or unsubstituted diol and a diimide compound of the formula:
Y—R′—X—R′—Y;
wherein R′ is independently selected from the group consisting of a substituted or unsubstituted alkenyl, allyl, alkyl, aryl, aralkyl, alkaryl, and cycloalkyl;
Y is selected from the group consisting of hydroxy, alkoxy, aryloxy, OM, COOR₁, NR₂R₃ group wherein M is a metal cation or ammonium cation and wherein R₁, R₂, R₃ are independently selected from the group consisting of a substituted and unsubstituted alkenyl, allyl, alkyl, aryl, aralkyl, alkaryl, cycloalkyl groups and hydrogen;
X is of the formula: 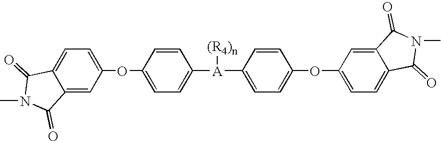
wherein A comprises a sulfur-containing linkage, sulfide, sulfoxide, sulfone; a phosphorus-containing linkage, phosphinyl, phosphonyl; an ether linkage; a carbonyl group; a tertiary nitrogen group; a silicon-containing linkage; silane; siloxy; a cycloaliphatic group; cyclopentylidene, cyclohexylidene, 3,3,5-trimethylcyclohexylidene, methylcyclohexylidene, 2-[2.2.1]-bicycloheptylidene, neopentylidene, cyclopentadecylidene, cyclododecylidene, adamantylidene; an alkylene or alkylidene group, which group may optionally be part of one or more fused rings attached to one or more aromatic groups bearing one hydroxy substituent; an unsaturated alkylidene group; or two or more alkylene or alkylidene groups connected by a moiety different from alkylene or alkylidene and selected from the group consisting of an aromatic linkage, a tertiary nitrogen linkage; an ether linkage; a carbonyl linkage; a silicon-containing linkage, silane, siloxy; a sulfur-containing linkage, sulfide, sulfoxide, sulfone; a phosphorus-containing linkage, phosphinyl, and phosphonyl; R₄ is selected from the group consisting of a substituted and unsubstituted alkenyl, allyl, alkyl, aryl, aralkyl, alkaryl, or cycloalkyl groups; the letter “n” represents any integer from and including zero through the number of replaceable hydrogens on R₄ available for substitution.

2. The composition of claim 1, wherein said diol is at least one selected from the group consisting of straight chain, branched, or cycloaliphatic alkane diols containing about 2 to 20 carbon atoms.

3. The process of claim 1, wherein said diol is at least one selected from the group consisting of ethylene glycol; propylene glycol, pentane diol; dipropylene glycol; 2-methyl-1,5-pentane diol; 1,6-hexane diol; dimethanol decalin, dimethanol bicyclo octane; 1,4-cyclohexane dimethanol and particularly its cis- and trans-isomers; triethylene glycol; 1,10-decane diol; tricyclodecane dimethanol; hydrogenated bisphenol-A, tetramethyl cyclobutane diol.

4. The composition of claim 1, wherein said diacid is at least one selected from the group consisting of linear acids, cycloaliphatic acids, bicyclo aliphatic acids, decahydro naphthalene dicarboxylic acids, norbornene dicarboxylic acids, bicyclo octane dicarboxylic acids, 1,4-cyclohexanedicarboxylic acid, adipic acid, azelaic acid, dicarboxyl dodecanoic acid, and succinic acid, dialkyl esters, diaryl esters, anhydrides, salts, acid chlorides, acid bromides.

5. The composition of claim 1, wherein said diacid is at least one selected from the group consisting of 1,4-cyclohexanedicarboxylic acid, dialkyl esters of 1,4-cyclohexanedicarboxylic acid.

6. The composition of claim 1, wherein said diacid is present in a range of between about 1 mole percent and about 99 mole percent.

7. The composition of claim 1, wherein said diimide compound is present in a range of between about 5 mole percent and about 95 mole percent.

8. The composition of claim 1, wherein said diimide compound is present in a range of between about 15 mole percent and about 85 mole percent.

9. The composition of claim 1, wherein X is of the formula:

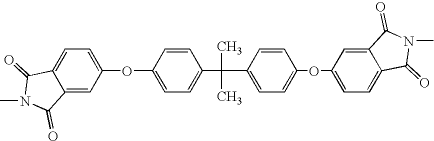

10. The composition of claim 1, wherein said copolymer has molecular weight in the range between about 12,000 to about 95,000.

11. The composition of claim 1, wherein said composition has a glass transition temperature of between about 80° C. and about 195° C.

12. An article comprising the composition of claim 1.

13. A polyester composition comprising: structural units derived from a diimde compound of the formula:
Y—R′—X—R′—Y;
and structural units derived from a second diimde compound of the formula:
Z-R′″—X′—R′″-Z
wherein R′ and R′″ are independently selected from the group consisting of a substituted or unsubstituted alkenyl, allyl, alkyl, aryl, aralkyl, alkaryl, and cycloalkyl;
X and X′ are of the formula: 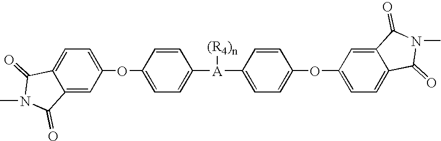
wherein A comprises a sulfur-containing linkage, sulfide, sulfoxide, sulfone; a phosphorus-containing linkage, phosphinyl, phosphonyl; an ether linkage; a carbonyl group; a tertiary nitrogen group; a silicon-containing linkage; silane; siloxy; a cycloaliphatic group; cyclopentylidene, cyclohexylidene, 3,3,5-trimethylcyclohexylidene, methylcyclohexylidene, 2-[2.2.1]-bicycloheptylidene, neopentylidene, cyclopentadecylidene, cyclododecylidene, adamantylidene; an alkylene or alkylidene group, which group may optionally be part of one or more fused rings attached to one or more aromatic groups bearing one hydroxy substituent; an unsaturated alkylidene group; or two or more alkylene or alkylidene groups connected by a moiety different from alkylene or alkylidene and selected from the group consisting of an aromatic linkage, a tertiary nitrogen linkage; an ether linkage; a carbonyl linkage; a silicon-containing linkage, silane, siloxy; a sulfur-containing linkage, sulfide, sulfoxide, sulfone; a phosphorus containing linkage, phosphinyl, and phosphonyl; R₄ is selected from the group consisting of a substituted and unsubstituted alkenyl, allyl, alkyl, aryl, aralkyl, alkaryl, or cycloalkyl groups; the letter “n” represents any integer from and including zero through the number of replaceable hydrogens on R₄ available for substitution; and wherein X and X′ may be same or different;
Y is selected from the group consisting of hydroxy, alkoxy and aryloxy; and Z is COOR₁, wherein R₁ are independently selected from the group consisting of a substituted and unsubstituted alkenyl, allyl, alkyl, aryl, aralkyl, alkaryl, cycloalkyl groups or hydrogen;

14. A process to prepare a copolymer composition comprising: structural units derived from a substituted or unsubstituted diacid or diester, a substituted or unsubstituted diol and a diimide compound of the formula:
Y—R′—X—R′—Y;
wherein R′ is independently selected from the group consisting of a substituted or unsubstituted alkenyl, allyl, alkyl, aryl, aralkyl, alkaryl, and cycloalkyl;
Y is selected from the group consisting of hydroxy, alkoxy, aryloxy, OM, COOR₁, NR₂R₃ group wherein M is a metal cation or ammonium cation and wherein R₁, R₂, R₃ are independently selected from the group consisting of a substituted and unsubstituted alkenyl, allyl, alkyl, aryl, aralkyl, alkaryl, cycloalkyl groups, and hydrogen;
X is of the formula: 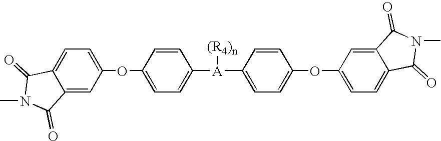
wherein A comprises a sulfur-containing linkage, sulfide, sulfoxide, sulfone; a phosphorus-containing linkage, phosphinyl, phosphonyl; an ether linkage; a carbonyl group; a tertiary nitrogen group; a silicon-containing linkage; silane; siloxy; a cycloaliphatic group; cyclopentylidene, cyclohexylidene, 3,3,5-trimethylcyclohexylidene, methylcyclohexylidene, 2-[2.2.1]-bicycloheptylidene, neopentylidene, cyclopentadecylidene, cyclododecylidene, adamantylidene; an alkylene or alkylidene group, which group may optionally be part of one or more fused rings attached to one or more aromatic groups bearing one hydroxy substituent; an unsaturated alkylidene group; or two or more alkylene or alkylidene groups connected by a moiety different from alkylene or alkylidene and selected from the group consisting of an aromatic linkage, a tertiary nitrogen linkage; an ether linkage; a carbonyl linkage; a silicon-containing linkage, silane, siloxy; a sulfur-containing linkage, sulfide, sulfoxide, sulfone; a phosphorus-containing linkage, phosphinyl, and phosphonyl; R₄ is selected from the group consisting of a substituted and unsubstituted alkenyl, allyl, alkyl, aryl, aralkyl, alkaryl, or cycloalkyl groups; the letter “n” represents any integer from and including zero through the number of replaceable hydrogens on R₄ available for substitution; and wherein said process comprises:
a. mixing said diacid, diol and diimide to form a first mixture;
b. heating said first mixture in presence of a catalyst to form said copolymer.

15. The process of claim 14, wherein said diol is at least one selected from the group consisting of ethylene glycol; propylene glycol, pentane diol; dipropylene glycol; 2-methyl-1,5-pentane diol; 1,6-hexane diol; dimethanol decalin, dimethanol bicyclo octane; 1,4-cyclohexane dimethanol and particularly its cis- and trans-isomers; triethylene glycol; 1,10-decane diol; tricyclodecane dimethanol; hydrogenated bisphenol-A, tetramethyl cyclobutane diol.

16. The process of claim 14, wherein said diacid is at least one selected from the group consisting of linear acids, cycloaliphatic acids, bicyclo aliphatic acids, decahydro naphthalene dicarboxylic acids, norbornene dicarboxylic acids, bicyclo octane dicarboxylic acids, 1,4-cyclohexanedicarboxylic acid, adipic acid, azelaic acid, dicarboxyl dodecanoic acid, and succinic acid, dialkyl esters, diaryl esters, anhydrides, salts, acid chlorides, acid bromides.

17. The process of claim 14, wherein said catalyst is at least one selected from the group consisting of metal salts and chelates of tin, zinc, germanium, gallium, antinomy, calcium, lithium, titanium.

18. The process of claim 14, wherein said catalyst is at least one selected from the group consisting of titanium alkoxides, dialkyl tin compounds, diacetate and oxides salts of magnesium, diacetate and oxides salts of calcium, diacetate and oxides salts of germanium, diacetate and oxides salts of zinc, diacetate and oxides salts of antimony.

19. The process of claim 14, wherein said catalyst is present in a range of between about 10 and about 1000 parts per million.

20. The process of claim 14, wherein said heating is carried out at a temperature between about 150° C. and about 350° C.

21. The process of claim 14, wherein said mixing may optionally be carried out in presence of a solvent.

22. The process of claim 21, wherein said solvent is at least one selected from the group consisting of amide solvents, methylene chloride, chloroform, dichlororethane, tetrahydrofuran, diethylether, dioxane, benzene, toluene, dichlorobenzene, chlorobenzene.

23. A thermoplastic resin composition comprising: structural units derived from a substituted or unsubstituted polymer resin and a copolymer composition comprising: structural units derived from a substituted or unsubstituted diacid, a substituted or unsubstituted diol and a diimide compound of the formula:
Y—R′—X—R′—Y;
wherein R′ is independently selected from the group consisting of a substituted or unsubstituted alkenyl, allyl, alkyl, aryl, aralkyl, alkaryl, and cycloalkyl;
Y is selected from the group consisting of hydroxy, alkoxy, aryloxy, OM, COOR₁, NR₂R₃ group wherein M is a metal cation or ammonium cation and wherein R₁, R₂, R₃ are independently selected from the group consisting of a substituted and unsubstituted alkenyl, allyl, alkyl, aryl, aralkyl, alkaryl, cycloalkyl groups, and hydrogen;
X is of the formula: 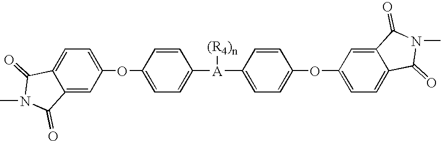
wherein A comprises a sulfur-containing linkage, sulfide, sulfoxide, sulfone; a phosphorus-containing linkage, phosphinyl, phosphonyl; an ether linkage; a carbonyl group; a tertiary nitrogen group; a silicon-containing linkage; silane; siloxy; a cycloaliphatic group; cyclopentylidene, cyclohexylidene, 3,3,5-trimethylcyclohexylidene, methylcyclohexylidene, 2-[2.2.1]-bicycloheptylidene, neopentylidene, cyclopentadecylidene, cyclododecylidene, adamantylidene; an alkylene or alkylidene group, which group may optionally be part of one or more fused rings attached to one or more aromatic groups bearing one hydroxy substituent; an unsaturated alkylidene group; or two or more alkylene or alkylidene groups connected by a moiety different from alkylene or alkylidene and selected from the group consisting of an aromatic linkage, a tertiary nitrogen linkage; an ether linkage; a carbonyl linkage; a silicon-containing linkage, silane, siloxy; a sulfur-containing linkage, sulfide, sulfoxide, sulfone; a phosphorus-containing linkage, phosphinyl, and phosphonyl; R₄ is selected from the group consisting of a substituted and unsubstituted alkenyl, allyl, alkyl, aryl, aralkyl, alkaryl, or cycloalkyl groups; the letter “n” represents any integer from and including zero through the number of replaceable hydrogens on R₄ available for substitution.

24. The composition of claim 23, wherein said polymer resin is selected from the group consisting of polyvinyl chloride, polyolefins, polyesters, polyamides, polysulfones, polyimides, polyetherimides, polyether sulfones, polyphenylene sulfides, polyether ketones, polyether ether ketones, ABS resins, polystyrenes, polybutadiene, polyacrylates, polymethacrylates, polyacrylonitrile, polyacetals, polycarbonates, polyphenylene ethers, ethylene-vinyl acetate copolymers, polyvinyl acetate, liquid crystal polymers, ethylene-tetrafluoroethylene copolymers, aromatic polyesters, polyvinyl fluoride, polyvinylidene fluoride, polyvinylidene chloride, tetrafluoroethylene, and mixtures, copolymers, reaction products, and composites comprising at least one of the foregoing thermoplastics.

25. The composition of claim 24, wherein said polymer resin is polycarbonate

26. The composition of claim 25, wherein said polycarbonate comprises repeating units of the formula: 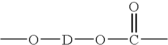
wherein D is a divalent aromatic radical derived from a dihydroxyaromatic compound of the formula HO-D-OH, wherein D has the structure of formula: 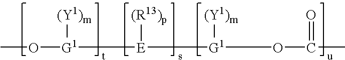
wherein G¹ represents an aromatic group; E comprises a sulfur-containing linkage, sulfide, sulfoxide, sulfone; a phosphorus-containing linkage, phosphinyl, phosphonyl; an ether linkage; a carbonyl group; a tertiary nitrogen group; a silicon-containing linkage; silane; siloxy; a cycloaliphatic group; cyclopentylidene, cyclohexylidene, 3,3,5-trimethylcyclohexylidene, methylcyclohexylidene, 2-[2.2.1]-bicycloheptylidene, neopentylidene, cyclopentadecylidene, cyclododecylidene, adamantylidene; an alkylene or alkylidene group, which group may optionally be part of one or more fused rings attached to one or more aromatic groups bearing one hydroxy substituent; an unsaturated alkylidene group; or two or more alkylene or alkylidene groups connected by a moiety different from alkylene or alkylidene and selected from the group consisting of an aromatic linkage, a tertiary nitrogen linkage; an ether linkage; a carbonyl linkage; a silicon-containing linkage, silane, siloxy; a sulfur-containing linkage, sulfide, sulfoxide, sulfone; a phosphorus-containing linkage, phosphinyl, and phosphonyl;
R¹³ independently at each occurrence comprises a mono-valent hydrocarbon group, alkenyl, allyl, alkyl, aryl, aralkyl, alkaryl, or cycloalkyl;
Y¹ independently at each occurrence is selected from the group consisting of an inorganic atom, a halogen; an inorganic group, a nitro group; an organic group, a monovalent hydrocarbon group, alkenyl, allyl, alkyl, aryl, aralkyl, alkaryl, cycloalkyl, and an alkoxy group;
the letter “m” represents any integer from and including zero through the number of replaceable hydrogens on G¹ available for substitution;
the letter “p” represents an integer from and including zero through the number of replaceable hydrogens on E available for substitution;
the letter “t” represents an integer equal to at least one;
the letter “s” represents an integer equal to either zero or one; and
“u” represents any integer including zero.

27. The composition of claim 23, wherein the dihydroxyaromatic compound from which D is derived is bisphenol A.

28. The composition of claim 23, wherein said diol is at least one selected from the group consisting of straight chain, branched, or cycloaliphatic alkane diols containing about 2 to 20 carbon atoms.

29. The composition of claim 23, wherein said diol is at least one selected from the group consisting of ethylene glycol; propylene glycol, pentane diol; dipropylene glycol; 2-methyl-1,5-pentane diol; 1,6-hexane diol; dimethanol decalin, dimethanol bicyclo octane; 1,4-cyclohexane dimethanol and particularly its cis- and trans-isomers; triethylene glycol; 1,10-decane diol; tricyclodecane dimethanol; hydrogenated bisphenol-A, tetramethyl cyclobutane diol.

30. The composition of claim 23, wherein said diacid is at least one selected from the group consisting of linear acids, cycloaliphatic acids, bicyclo aliphatic acids, decahydro naphthalene dicarboxylic acids, norbornene dicarboxylic acids, bicyclo octane dicarboxylic acids, 1,4-cyclohexanedicarboxylic acid, adipic acid, azelaic acid, dicarboxyl dodecanoic acid, and succinic acid, dialkyl esters, diaryl esters, anhydrides, salts, acid chlorides, acid bromides.

31. The composition of claim 23, wherein said diacid is at least one selected from the group consisting of 1,4-cyclohexanedicarboxylic acid, dialkyl esters of 1,4-cyclohexanedicarboxylic acid.

32. The composition of claim 23, wherein said thermoplastic resin composition comprises structural units derived from copolymer and polymer resin in a range of about 90-10 percent by weight of copolymer and 10-90 percent by weight of polycarbonate.

33. The composition of claim 23, wherein said thermoplastic resin composition comprises structural units derived from copolymer and polymer resin in a range of about 75-25 percent by weight of copolymer and 25-75 percent by weight of polycarbonate.

34. The composition of claim 23, wherein said thermoplastic resin composition has a glass transition in the range of between about 80° C. and about 195° C.

35. The composition of claim 23, further comprises the addition of a stabilizing additive.

36. The composition of claim 23, wherein said acidic stabilizing additive is selected from the group consisting of anti-oxidants, flame retardants, reinforcing materials, colorants, mold release agents, fillers, nucleating agents, UV light stabilizers, heat stabilizers, lubricants, antioxidants flame retardants, pigments or combinations thereof

37. The composition of claim 23, wherein said stabilizing additive is present at a level from about 2 to about 30 percent by weight based on the total weight of said composition.

38. An article comprising the composition of claim 23.

39. A process to prepare a thermoplastic resin composition comprising: structural units derived from a substituted or unsubstituted polymer resin and a copolymer composition comprising: structural units derived from a substituted or unsubstituted diacid, a substituted or unsubstituted diol and a diimide compound of the formula:
Y—R′—X—R′—Y;
wherein R′ is independently selected from the group consisting of a substituted or unsubstituted alkenyl, allyl, alkyl, aryl, aralkyl, alkaryl, and cycloalkyl;
Y is selected from the group consisting of hydroxy, alkoxy, aryloxy, OM, COOR₁, NR₂R₃ group wherein M is a metal cation or ammonium cation and wherein R₁, R₂, R₃ are independently selected from the group consisting of a substituted and unsubstituted alkenyl, allyl, alkyl, aryl, aralkyl, alkaryl, cycloalkyl groups, and hydrogen;
X is of the formula: 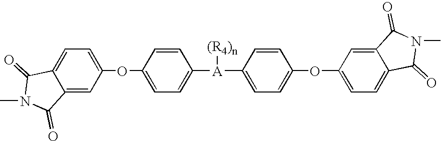
wherein A comprises a sulfur-containing linkage, sulfide, sulfoxide, sulfone; a phosphorus-containing linkage, phosphinyl, phosphonyl; an ether linkage; a carbonyl group; a tertiary nitrogen group; a silicon-containing linkage; silane; siloxy; a cycloaliphatic group; cyclopentylidene, cyclohexylidene, 3,3,5-trimethylcyclohexylidene, methylcyclohexylidene, 2-[2.2.1]-bicycloheptylidene, neopentylidene, cyclopentadecylidene, cyclododecylidene, adamantylidene; an alkylene or alkylidene group, which group may optionally be part of one or more fused rings attached to one or more aromatic groups bearing one hydroxy substituent; an unsaturated alkylidene group; or two or more alkylene or alkylidene groups connected by a moiety different from alkylene or alkylidene and selected from the group consisting of an aromatic linkage, a tertiary nitrogen linkage; an ether linkage; a carbonyl linkage; a silicon-containing linkage, silane, siloxy; a sulfur-containing linkage, sulfide, sulfoxide, sulfone; a phosphorus containing linkage, phosphinyl, and phosphonyl; R₄ is selected from the group consisting of a substituted and unsubstituted alkenyl, allyl, alkyl, aryl, aralkyl, alkaryl, or cycloalkyl groups; the letter “n” represents any integer from and including zero through the number of replaceable hydrogens on R₄ available for substitution.; and
wherein said process comprises:
a. mixing the polymer resin and copolymer to form a mixture
b. heating said mixture to form (optically) clear thermoplastic resin composition.

40. The process according to claim 39, wherein said mixing may optionally be carried out at in temperature range between about 80° C. and about 350° C.

41. The process according to claim 39, wherein said heating is carried out at in temperature range between about 150° C. and about 280° C.

42. The process of claim 39, further comprises the addition of a stabilizing additive.

43. The process of claim 39, wherein said acidic stabilizing additive is selected from the group consisting of anti-oxidants, flame retardants, reinforcing materials, colorants, mold release agents, fillers, nucleating agents, UV light stabilizers, heat stabilizers, lubricants, antioxidants flame retardants, pigments or combinations thereof

44. The process of claim 39, wherein said stabilizing additive is present at a level from about 2 to about 30 percent by weight based on the total weight of said composition.

45. The process of claim 39, wherein said diol is at least one selected from the group consisting of straight chain, branched, or cycloaliphatic alkane diols containing about 2 to 20 carbon atoms.

46. The process of claim 39, wherein said diol is at least one selected from the group consisting of ethylene glycol; propylene glycol, pentane diol; dipropylene glycol; 2-methyl-1,5-pentane diol; 1,6-hexane diol; dimethanol decalin, dimethanol bicyclo octane; 1,4-cyclohexane dimethanol and particularly its cis- and trans-isomers; triethylene glycol; 1,10-decane diol; tricyclodecane dimethanol; hydrogenated bisphenol-A, tetramethyl cyclobutane diol.

47. The process of claim 39, wherein said diacid is at least one selected from the group consisting of linear acids, cycloaliphatic acids, bicyclo aliphatic acids, decahydro naphthalene dicarboxylic acids, norbornene dicarboxylic acids, bicyclo octane dicarboxylic acids, 1,4-cyclohexanedicarboxylic acid, adipic acid, azelaic acid, dicarboxyl dodecanoic acid, and succinic acid, dialkyl esters, diaryl esters, anhydrides, salts, acid chlorides, acid bromides.

48. The process of claim 39, wherein said diacid is at least one selected from the group consisting of 1,4-cyclohexanedicarboxylic acid, dialkyl esters of 1,4-cyclohexanedicarboxylic acid.
